(19) United States
(12) Patent Application Publication
(10) Pub. No.: US 2024/0217205 A1
(43) Pub. Date: Jul. 4, 2024

(54) FIBER REINFORCED THERMOPLASTIC COMPOSITE ARTICLES INCLUDING REPRODUCED POLYMERIC FIBERS

(71) Applicant: HANWHA AZDEL, INC., Forest, VA (US)

(72) Inventors: Hongyu Chen, Forest, VA (US); Liqing Wei, Forest, VA (US); Ruomiao Wang, Forest, VA (US); Dongjie Chen, Forest, VA (US)

(21) Appl. No.: 18/383,699

(22) Filed: Oct. 25, 2023

Related U.S. Application Data
(60) Provisional application No. 63/419,634, filed on Oct. 26, 2022.
(60) Provisional application No. 63/522,043, filed on Jun. 20, 2023.

(51) Int. Cl. B32B 5/26; B32B 5/02

(52) U.S. Cl. CPC B32B 5/26; B32B 5/02; B32B 2260/021; B32B 2260/046; B32B 2605/00

(57) ABSTRACT

Thermoplastic composite articles are described that comprise reproduced polymeric fibers in one or more of a core layer and a skin layer. In certain arrangements, the thermoplastic composite article can include a porous core layer comprising a web of open celled structures comprising random crossing over of a plurality of reinforcing fibers and a plurality of reproduced polymeric fibers held together by a thermoplastic material, and a skin layer disposed on a first surface of the porous core layer. The thermoplastic material can include virgin and recycled thermoplastic materials if desired. Exterior and interior components produced using the thermoplastic composite articles are also described.

### PRIORITY APPLICATIONS

This application claims priority to and the benefit of each of U.S. Provisional Application No. 63/419,634 filed on Oct. 26, 2022 and U.S. Provisional Application No. 63/522,043 filed on Jun. 20, 2023, the entire disclosure of each of which is hereby incorporated herein by reference.

### TECHNOLOGICAL FIELD

Fiber reinforced thermoplastic composite articles with reproduced polymeric fibers are described. In some configurations, the composite articles include a plurality of reinforcing fibers some of which may be reproduced polymeric fibers. Recycled thermoplastic materials can also be present if desired.

### BACKGROUND

Composite articles often include various materials that impart desired properties to the articles. The exact materials selected can depend on the intended use of the composite articles.

### SUMMARY

Certain aspects and features are described in reference to composite articles that can include reproduced polymeric fibers in one or more layers of the composite article. In some embodiments, the reproduced polymeric fibers can be present on one or more of a core layer, a skin layer or both. If desired, the composite article can also include recycled thermoplastic materials either alone or in combination with the reproduced polymeric fibers and/or biomaterials.

In an aspect, a thermoplastic composite article comprises a porous core layer comprising a web of open celled structures comprising random crossing over of a plurality of reinforcing fibers and a plurality of reproduced polymeric fibers held together by a thermoplastic material, and a skin layer disposed on a first surface of the porous core layer.

In certain embodiments, the reproduced polymeric fibers are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof. In other embodiments, the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethylene terephthalate, a polybutylene terephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some embodiments, the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, biofibers, rice hull fibers, Kenaf fibers and combinations thereof.

In certain embodiments, the skin layer is selected from the group consisting of a fabric, a film, a scrim, a frim, a porous non-woven material, a porous knit material, a decorative layer, and combinations thereof.

In other embodiments, the plurality of reinforcing fibers are present from 20 weight percent to 80 weight percent based on the weight of the porous core layer. In some examples, the plurality of reproduced polymeric fibers are present from 20 weight percent to 80 weight percent based on the weight of the porous core layer.

In other embodiments, the plurality of reproduced polymeric fibers comprise a different monomer unit than a monomer unit of the plurality of reinforcing fibers. In some examples, the plurality of reproduced polymeric fibers and the plurality of reinforcing fibers each comprise a similar average diameter and average length.

In some configurations, the thermoplastic composite article is constructed and arranged as a vehicular panel, a vehicular underbody panel, an exterior automotive part, an interior automotive part, an automotive headliner, a recreational vehicle panel or a recreational vehicle part.

In other embodiments, the skin layer comprises a plurality of reproduced polymeric fibers. In certain embodiments, the plurality of reproduced polymeric fibers of the porous core layer and the plurality of reproduced polymeric fibers of the skin layer independently are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof. In other embodiments, the plurality of reproduced polymeric fibers of the porous core layer and the plurality of reproduced polymeric fibers of the skin layer comprise a different monomer unit.

In additional embodiments, the thermoplastic material of the porous core layer comprises at least one of a virgin polyethylene, a virgin polypropylene, a virgin polystyrene, a virgin polyimide, a virgin polyetherimide, a virgin acrylonitrylstyrene, a virgin butadiene, a virgin polyethylene terephthalate, a virgin polybutylene terephthalate, a virgin polybutylenetetrachlorate, a virgin polyvinyl chloride, a virgin polyphenylene ether, a virgin polycarbonate, a virgin polyestercarbonate, a virgin polyester, a virgin acrylonitrile-butylacrylate-styrene polymer, a virgin amorphous nylon, a virgin polyarylene ether ketone, a virgin polyphenylene sulfide, a virgin polyaryl sulfone, a virgin polyether sulfone, a virgin poly(1,4 phenylene) compound, a recycled polyethylene, a recycled polypropylene, a recycled polystyrene, a recycled polyimide, a recycled polyetherimide, a recycled acrylonitrylstyrene, a recycled butadiene, a recycled polyethylene terephthalate, a recycled polybutylene terephthalate, a recycled polybutylenetetrachlorate, a recycled polyvinyl chloride, a recycled polyphenylene ether, a recycled polycarbonate, a recycled polyestercarbonate, a recycled polyester, a recycled acrylonitrile-butylacrylate-styrene polymer, a recycled amorphous nylon, a recycled polyarylene ether ketone, a recycled polyphenylene sulfide, a recycled polyaryl sulfone, a recycled polyether sulfone, a recycled poly(1,4 phenylene) compound, a recycled silicone and mixtures thereof.

In some configurations, the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof.

In other configurations, the skin layer is selected from the group consisting of a fabric, a film, a scrim, a frim, a porous non-woven material, a porous knit material, a decorative layer, and combinations thereof.

In other examples, the plurality of reinforcing fibers and the plurality of reproduced polymeric fibers of the porous core layer are independently present from 20 weight percent to 80 weight percent based on the weight of the porous core layer. In some examples, the plurality of reproduced polymeric fibers of the skin layer comprise a different monomer unit than a monomer unit of the plurality of reinforcing fibers of the porous core layer.

In some instances, the thermoplastic material of the porous core layer comprises virgin polyolefin material or recycled polyolefin material or both, the plurality of reinforcing fibers of the porous core layer comprise glass fibers, and the plurality of reproduced polymeric fibers of the porous core layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

In other configurations, the thermoplastic material of the porous core layer comprises virgin polyolefin material or recycled polyolefin material or both, the plurality of reinforcing fibers of the porous core layer comprise glass fibers, and the plurality of reproduced polymeric fibers of the skin layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

In another aspect, a thermoplastic composite article comprises a porous core layer comprising a web of open celled structures comprising random crossing over of a plurality of reinforcing fibers and held together by a thermoplastic material, and a skin layer disposed on a first surface of the porous core layer, wherein the skin layer comprises a plurality of reproduced polymeric fibers.

In some embodiments, the plurality of reproduced polymeric fibers of the skin layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof. In other embodiments, the plurality of reinforcing fibers of the porous core layer and the plurality of reproduced polymeric fibers of the skin layer comprise a common monomer unit. In some examples, the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethylene terephthalate, a polybutylene terephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In certain embodiments, the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof.

In some embodiments, the skin layer is selected from the group consisting of a fabric, a film, a scrim, a frim, a porous non-woven material, a porous knit material, a decorative layer, and combinations thereof.

In certain examples, the plurality of reinforcing fibers are present from 20 weight percent to 80 weight percent based on the weight of the porous core layer.

In certain configurations, the plurality of reproduced polymeric fibers of the skin layer comprise a different monomer unit than a monomer unit of the plurality of reinforcing fibers of the porous core layer.

In other embodiments, the thermoplastic composite article is constructed and arranged as a vehicular panel, a vehicular underbody panel, an exterior automotive part, an interior automotive part, an automotive headliner, a recreational vehicle panel or a recreational vehicle part.

In some embodiments, the plurality of thermoplastic material of the porous core layer comprises virgin polyolefin material or recycled polyolefin material or both, the plurality of reinforcing fibers of the porous core layer comprise glass fibers, and the reproduced polymeric fibers of the skin layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

In an additional aspect, a method of producing a thermoplastic composite article comprises adding a plurality of reinforcing fibers, a plurality of reproduced polymeric fibers and a thermoplastic material to an agitated aqueous foam to form a dispersed mixture. The method can also include depositing the dispersed mixture of the plurality of reinforcing fibers, the reproduced polymeric fibers and the thermoplastic material onto a forming support element. The method can also include evacuating liquid from the deposited, dispersed mixture to form a web. The method can also include heating the web above a softening temperature of the thermoplastic material; compressing the heated web to a predetermined thickness. The method can also include disposing a skin layer on the compressed web to provide the thermoplastic composite article.

In certain embodiments, the skin layer comprises a plurality of reproduced polymeric fibers. In other embodiments, the thermoplastic material comprises a mixture of virgin thermoplastic material and recycled thermoplastic material.

In another aspect, a method of producing a thermoplastic composite article comprises adding a plurality of reinforcing fibers and a thermoplastic material to an agitated aqueous foam to form a dispersed mixture. The method can also include depositing the dispersed mixture of the plurality of reinforcing fibers and the thermoplastic material onto a forming support element. The method can also include evacuating liquid from the deposited, dispersed mixture to form a web. The method can also include heating the web above a softening temperature of the thermoplastic material; compressing the heated web to a predetermined thickness. The method can also include disposing a skin layer on the compressed web to provide the thermoplastic composite article, wherein the skin layer comprises a plurality of reproduced polymeric fibers.

In some embodiments, the thermoplastic material comprises a mixture of virgin thermoplastic material and recycled thermoplastic material.

Additional aspects, embodiments, configurations, examples, features and elements are described in more detail below.

### BRIEF DESCRIPTION OF THE SEVERAL VIEWS OF THE DRAWINGS

Certain specific illustrations are described in reference to the accompanying figures in which:

FIG. 1 is an illustration of a core layer comprising a thermoplastic material and reproduced polymeric fibers, in accordance with certain embodiments;

FIG. 2 is an illustration of a fiber reinforced thermoplastic composite article including a core layer comprising a thermoplastic material and reproduced polymeric fibers in combination with a skin layer, in accordance with certain embodiments;

FIG. 3 is an illustration of a fiber reinforced thermoplastic composite article including a core layer comprising a thermoplastic material and reproduced polymeric fibers in combination with two skin layers, in accordance with certain embodiments;

FIG. 4 is an illustration of a fiber reinforced thermoplastic composite article including a core layer comprising a thermoplastic material and reproduced polymeric fibers in combination with a decorative layer, in accordance with certain embodiments;

FIG. 5 is an illustration of a fiber reinforced thermoplastic composite article including a core layer comprising a thermoplastic material and non-reproduced polymeric fibers in combination with a skin layer comprising reproduced polymeric fibers, in accordance with certain embodiments;

FIG. 6 is an illustration of a fiber reinforced thermoplastic composite article including a core layer comprising a thermoplastic material and non-reproduced polymeric fibers in combination with a skin layer comprising reproduced polymeric fibers and another skin layer, in accordance with certain embodiments;

FIG. 7 is an illustration of a fiber reinforced thermoplastic composite article including a core layer comprising a thermoplastic material and non-reproduced polymeric fibers in combination with a skin layer comprising reproduced polymeric fibers and a decorative layer, in accordance with certain embodiments;

FIG. 8 is an illustration of a core layer comprising a thermoplastic material and reproduced polymeric fibers coupled to a core layer comprising a thermoplastic material and non-reproduced polymeric fibers, in accordance with certain embodiments;

FIG. 9 is an illustration of a core layer comprising a thermoplastic material and reproduced polymeric fibers coupled to a core layer comprising a thermoplastic material and non-reproduced polymeric fibers in combination with a skin layer, in accordance with certain embodiments;

FIG. 10 is an illustration of a core layer comprising a thermoplastic material and reproduced polymeric fibers coupled to a core layer comprising a thermoplastic material and non-reproduced polymeric fibers in combination with a skin layer, in accordance with certain embodiments;

FIG. 11 is an illustration of a core layer comprising a thermoplastic material and reproduced polymeric fibers coupled to a core layer comprising a thermoplastic material and non-reproduced polymeric fibers in combination with two skin layers, in accordance with certain embodiments;

FIG. 12 is an illustration of a core layer comprising a thermoplastic material and reproduced polymeric fibers coupled to a core layer comprising a thermoplastic material and non-reproduced polymeric fibers in combination with a decorative layer, in accordance with certain embodiments;

FIG. 13 is an illustration of a core layer comprising a thermoplastic material and reproduced polymeric fibers coupled to a core layer comprising a thermoplastic material and non-reproduced polymeric fibers through a skin layer, in accordance with certain embodiments;

FIG. 14 is an illustration of a headliner, in accordance with certain embodiments;

FIG. 15 is an illustration of an underbody shield, in accordance with certain embodiments;

FIG. 16 is an illustration of interior trim, in accordance with certain embodiments;

FIG. 17 is an illustration of a ceiling panel, in accordance with certain embodiments;

FIG. 18 is an illustration of a cubicle panel, in accordance with certain embodiments;

FIG. 19 is an illustration of a structural panel, in accordance with certain embodiments;

FIG. 20 is another illustration of a structural panel, in accordance with certain embodiments;

FIG. 21 is an illustration of a wall panel, in accordance with certain examples;

FIG. 22 is an illustration of a siding panel, in accordance with certain examples;

FIG. 23 is an illustration of a roofing panel, in accordance with certain embodiments;

FIG. 24 is an illustration of a roofing shingle, in accordance with certain embodiments;

FIG. 25 is an illustration of an interior panel of a recreational vehicle, in accordance with certain embodiments;

FIG. 26 is an illustration of an exterior panel of a recreational vehicle, in accordance with certain embodiments;

FIG. 27 is an illustration of an interior trim, in accordance with certain embodiments;

FIG. 28 is an illustration of an automobile, in accordance with certain embodiments;

FIG. 29 is an illustration of a recreational vehicle, in accordance with certain embodiments;

FIG. 30 is an illustration of an airplane, in accordance with certain embodiments;

FIG. 31 is an illustration of a spacecraft, in accordance with certain embodiments;

FIG. 32, FIG. 33, FIG. 34, FIG. 35, FIG. 36, FIG. 37, FIG. 38, FIG. 39, FIG. 40, FIG. 41, FIG. 42 and FIG. 43 show the results of testing of certain formulations in Examples 1-3;

FIG. 44, FIG. 45, FIG. 46 and FIG. 47 shows the results of testing of certain formulations in Example 4;

FIG. 48, FIG. 49, FIG. 50 and FIG. 51 shows the results of testing of certain formulations in Example 5;

FIG. 52, FIG. 53, FIG. 54 and FIG. 55 shows the results of testing of certain formulations in Example 6;

FIG. 56, FIG. 57, FIG. 58, FIG. 59, FIG. 60, FIG. 61, FIG. 62 and FIG. 63 shows the results of testing of certain formulations in Example 7;

FIG. 64, FIG. 65, FIG. 66, FIG. 67, FIG. 68, FIG. 69, FIG. 70 and FIG. 71 shows the results of testing of certain formulations in Example 8;

FIG. 72, FIG. 73, FIG. 74, FIG. 75, FIG. 76, FIG. 77, FIG. 78, FIG. 79, and FIG. 80 shows the results of testing of certain formulations in Example 9;

FIG. 81, FIG. 82, FIG. 83, FIG. 84, FIG. 85, and FIG. 86 shows the results of testing of certain formulations in Example 10; and

FIG. 87, FIG. 88, FIG. 89, FIG. 90, FIG. 91, FIG. 92, FIG. 93, FIG. 94, FIG. 95, FIG. 96, FIG. 97, FIG. 98, FIG. 99, FIG. 100, FIG. 101 and FIG. 102 shows the results of testing of certain formulations in Example 11.

It will be recognized by the person having ordinary skill in the art, given the benefit of this disclosure, that the dimensions, sizes, shading, arrangement and other features in the figures are provided merely for illustration and are not intended to limit the technology to any one configuration, dimension or arrangement.

### DETAILED DESCRIPTION

Various components and features of fiber reinforced thermoplastic composite articles that include reproduced polymeric fibers in one, two, three or more different components or layers are discussed. As used herein, “reproduced polymeric fibers” refer to fibers that include materials that have been previously polymerized, subjected to one or more chemical or physical processes to place the previously polymerized materials in a suitable form to produce fibers and then formed into polymeric fibers. In some embodiments, the reproduced polymeric fibers may be produced from non-fibrous materials that have been converted into a suitable form to permit polymeric fiber production. In other embodiments, the reproduced polymeric fibers may be produced from fibrous materials which have an unsuitable size, diameter or properties for use in the thermoplastic composite articles described herein. For example, very short fibers, e.g., less than 2 mm in length, may be unsuitable to provide appropriate mechanical properties to the fiber reinforced thermoplastic composite articles described herein. The short fibers can be subjected to chemical and/or physical treatment to convert the short fibers into a suitable form to permit production of reproduced polymeric fibers having a suitable length and/or size. In some instances, the converted materials can be reproduced into polymeric fibers by forcing the fibers through holes in a die or other device to provide continuous polymeric filaments. For example, melt spinning, solution spinning, wet spinning, gel spinning, liquid crystal spinning, dispersion spinning, reaction spinning, electrospinning or other techniques can be performed using the converted materials to provide polymeric filaments. The polymeric filaments can then be cut and sized to provide suitable fiber lengths and diameters for use in the fiber reinforced thermoplastic composite articles described herein. Illustrative reproduced polymeric fiber sizes and dimensions are discussed below.

In certain embodiments, the exact polymeric materials used to produce the reproduced fibers may vary. For example, reproduced fibers can be produced from polyethylene terephthalate, polyethylene, polypropylene, polyamide, co-polyamide, reproduced high density polyethylene, low density polyethylene and combinations thereof. Other materials may also be converted including, for example, polystyrene and polyvinyl chloride, and used alone or in combination with another polymeric material. The polymeric material may have been previously polymerized and formed into other shapes or articles. The previously formed articles can be chopped, crushed, ground, pulverized, melted, softened or otherwise physically or chemically treated to convert the materials in the article to a suitable form to be used for polymeric fiber production. If desired, the converted material can be mixed with virgin polymeric material prior to fiber production. In other embodiments, the converted material can be used without addition of any virgin polymeric material to produce reproduced polymeric fibers. The converted material can be subjected to cleaning steps, depolymerization agents to convert at least some of the converted material to monomeric units, or other physical or chemical steps. In some embodiments, one or more of glycolysis, methanolysis, hydrolysis or treatment with other chemical agents or solvent may be performed on the material prior to using it to produce the reproduced polymeric fibers.

In some embodiments, the reproduced polymeric fibers can be produced from previously polymerized non-fibrous materials which are converted into a suitable form to be repolymerized into reproduced polymeric fibers. For example, the previously polymerized non-fibrous materials can be converted to non-fibrous materials, depolymerized and/or polymerized further and then spun or made into reproduced polymeric fibers. In other embodiments, the reproduced polymeric fibers may be converted to non-fibrous materials comprising monomers, repolymerized and then spun or made into reproduced polymeric fibers. While not wishing to be bound by any particular scientific theory, virgin polymeric fibers can be chemically or physically different than reproduced polymeric fibers. For example, the reproduced polymeric fibers may have a higher degree of polymerization (DP or Xₙ) compared to virgin polymeric fibers or may have a different chemical makeup as a result of the reproduction process. DP or Xₙ is typically calculated as a ratio of molecular weight of a polymer and molecular weight of the repeat unit. Number average DP and weight average DP are the two main types used for measuring the DP. In certain arrangements, the DP of the reproduced polymeric fibers may be at least 10% higher than the starting materials used to produce the reproduced polymeric fibers. In other configurations, the DP of the reproduced polymeric fibers may be at least 20% higher than the starting materials used to produce the reproduced polymeric fibers.

In certain embodiments, the exact size of individual reproduced polymeric fibers may vary. For example, the reproduced polymeric fibers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. The reproduced polymeric fibers may be twisted as a result of the fiber production process or can be untwisted and present as single reproduced polymeric fibers which generally do not cross over or intersect with other reproduced polymeric fibers. Without wishing to be bound by any particular configuration, untwisted reproduced polymeric fibers may provide smoother surfaces than twisted fibers or twisted reproduced polymeric fibers. The reproduced polymeric fibers are typically randomly oriented when present in the thermoplastic composite articles described herein, though if desired, the reproduced polymeric fibers could be oriented in suitable directions, e.g., at 0 degrees, 15 degrees, 30 degrees, 45 degrees, 60 degrees, 75 degrees or 90 degrees, relative to a machine direction used to produce the thermoplastic composite articles.

In other embodiments, the thermoplastic composite article can include one or more recycled thermoplastic materials. The recycled thermoplastic materials can be used in combination with the reproduced polymeric fibers or may be used in combination with non-reproduced fibers, e.g., glass fibers, inorganic fibers, organic fibers, polymeric fibers, etc. In some configurations, the thermoplastic materials present in a composite article may be a combination of virgin thermoplastic material and recycled thermoplastic material. For example, virgin polyolefin material can be mixed with recycled polyolefin material and the mixture can be used to produce a fiber reinforced thermoplastic composite article as described herein.

In some embodiments, the recycled thermoplastic material may be chemically similar or the same as the virgin thermoplastic material but may be physically different than the virgin thermoplastic material. For example, the recycled thermoplastic material may have a different color, particle size, shape, average glass transition temperature, crystallinity or other physical characteristics that are different than the virgin thermoplastic material even though the virgin thermoplastic material and the recycled thermoplastic material share the same underlying chemistry, e.g., the same monomers.

In some embodiments, the virgin thermoplastic material and the recycled thermoplastic material each comprise polyolefin materials, which can be the same or can be different. For example, each of the virgin and recycled thermoplastic materials can be a polyethylene (e.g., high density polyethylene, low density polyethylene, linear low density polyethylene), a polypropylene (e.g., homopolymer, random copolymer, and block copolymer), polybutene (e.g., 1-butene, 2-butene, and isobutylene) and other copolymers thereof. In some instances, the recycled polyolefin may comprise a blend of different recycled polyolefins, e.g., a blend or mixture of polyethylene and polypropylene.

In other configurations, the recycled thermoplastic material can be recycled polystyrene, recycled acrylonitrylstyrene, recycled butadiene, recycled polyethyleneterephthalate, recycled polybutyleneterephthalate, recycled polybutylenetetrachlorate, and recycled polyvinyl chloride, both plasticized and unplasticized, and blends of these materials with each other or other polymeric materials. Other suitable recycled thermoplastics include, but are not limited to, recycled polyarylene ethers, recycled polycarbonates, recycled polyestercarbonates, recycled thermoplastic polyesters, recycled polyimides, recycled polyetherimides, recycled polyamides, recycled co-polyamides, recycled acrylonitrile-butylacrylate-styrene polymers, recycled amorphous nylon, recycled polyarylene ether ketone, recycled polyphenylene sulfide, recycled polyaryl sulfone, recycled polyether sulfone, recycled liquid crystalline polymers, recycled poly(1,4 phenylene) compounds commercially known as PARMAX®, recycled high heat polycarbonate such as Bayer's APEC® PC, recycled high temperature nylon, and recycled silicones, as well as copolymers, alloys and blends of these materials with each other or other polymeric materials. The recycled thermoplastic material used to form the core layer can be used in powder form, resin form, rosin form, particle form, fiber form or other suitable forms.

In certain embodiments, the exact total amount of thermoplastic material (virgin, recycled or both) present in the core layer can vary and illustrative amounts range from about 20% by weight to about 80% by weight, e.g., 30-70 percent by weight or 35-65 percent by weight, based on the total weight of the core layer. Recycled thermoplastic materials are commercially available from numerous suppliers including, but not limited to, Solvay Chemicals, Inc. (Alorton, IL), Primex Plastics (Richmond, IN), Arkema Inc. (King of Prussia, PA) and other suppliers of recycled thermoplastic materials.

In other instances, all of the thermoplastic material in the composite article may be recycled thermoplastic material. Such recycled thermoplastic material can be used with non-reproduced fiber or reproduced fibers or both as desired.

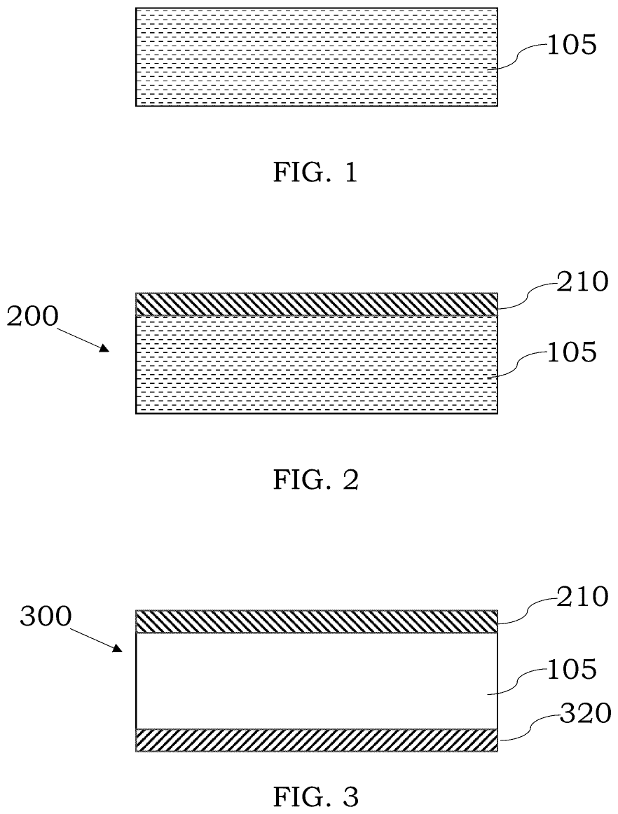

In certain configurations, a fiber reinforced thermoplastic composite article can include a porous core layer comprising a web of open celled structures comprising random crossing over of a plurality of reproduced polymeric fibers held together by a thermoplastic material, which can be virgin thermoplastic material, recycled thermoplastic material or combinations thereof. Referring to FIG. 1, a core layer 105 is shown that comprises the reproduced polymeric fibers and the thermoplastic material. The core layer 105 is typically porous, e.g., is a porous core layer, with a porosity that can vary from more than 0% by volume up to about 95% by volume of the porous core layer. For example, the porous core layer 105 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% by volume of the porous core layer or any illustrative value within these exemplary ranges.

In certain embodiments, the thermoplastic material of the porous core layer 105 can include virgin and/or recycled polyolefin and/or non-polyolefin materials. For example, the thermoplastic material of the core layer 105 comprises one or more of a virgin or recycled or both polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer 105 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the core layer 105. It will be recognized by the skilled person that the weight percentages of all materials used in the core layer 105 will add to 100 weight percent. The thermoplastic material in the core layer 105 can include only virgin material, only recycled material, or a combination of a virgin material and recycled material. Where a combination of virgin and recycled thermoplastic material are used, the recycled material can be chemically the same or different than the virgin material. Where the recycled material is chemically the same as the virgin material, the recycled material may be physically different than the virgin material, e.g., the recycled material may have a different color, particle size, shape, average glass transition temperature, crystallinity or other physical characteristics that are different than the virgin thermoplastic material even though the virgin thermoplastic material and the recycled thermoplastic material share the same underlying chemistry.

In certain configurations, the reproduced polymeric fibers in the porous core layer 105 can include one, two, three or more polymeric materials. For example, reproduced polymeric fibers in the core layer 105 can include one or more of reproduced polyethylene terephthalate fibers, reproduced polyethylene fibers, reproduced polypropylene fibers, reproduced polyamide fibers, reproduced nylon fibers, reproduced co-polyamide fibers, reproduced high density polyethylene fibers, glass fibers coated with a reproduced polymeric material and combinations thereof. In some configurations, the fibers may comprise reproduced glass fibers, e.g., glass fibers which have been recycled and/or reclaimed with optional physical and/or chemical treatment prior to reuse. The dimensions of different reproduced polymeric fibers can be the same or different. For example, the reproduced polymeric fibers in the core layer 105 can have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. The reproduced polymeric fibers in the core layer 105 may be twisted as a result of the fiber production process or can be untwisted and present as single reproduced polymeric fibers which generally do not cross over or intersect with other reproduced polymeric fibers. The reproduced polymeric fibers in the core layer 105 are typically randomly oriented when present in the porous core layer 105, though if desired, the reproduced polymeric fibers in the core layer 105 could be oriented in suitable directions, e.g., at 0 degrees, 15 degrees, 30 degrees, 45 degrees, 60 degrees, 75 degrees or 90 degrees, relative to a machine direction used to produce the thermoplastic composite articles. The reproduced polymeric fiber content in the porous core layer 105 can vary from about 5% by weight to about 90% by weight, more particularly about 5% by weight to about 80% by weight, e.g., about 5-10% by weight, 5-20% by weight, 5-30% by weight, 5-40% by weight, 5-50% by weight or about 20 weight percent to about 80 weight percent or other amounts. Depending on whether non-reproduced polymeric fibers are also present in the core layer 105, the exact amount of reproduced polymers fibers in the core layer 105 may be less or more as desired.

In certain embodiments, the porous core layer 105 can also include non-reproduced polymeric fibers or reinforcing fibers that are non-reproduced polymeric fibers, e.g., inorganic fibers, virgin polymeric fibers, etc. For example, the non-reproduced reinforcing fibers in the core layer 105 may comprise glass fibers, carbon fibers, graphite fibers, synthetic organic fibers, particularly high modulus organic fibers such as, for example, para- and meta-aramid fibers, nylon fibers, polyester fibers, natural fibers, cellulose fibers, a high melt flow index (MFI) resin (e.g., 100 g/10 min. MFI, 325 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some configurations, the fibers may comprise reproduced glass fibers, e.g., glass fibers which have been recycled and/or reclaimed with optional physical and/or chemical treatment prior to reuse. In certain embodiments, the fibers used may be cellulose free to avoid or reduce the likelihood of mold or other microbial growth. In some embodiments, the fibers in the core layer 105 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material, the reproduced polymeric fibers or both. The non-reproduced polymeric fiber content in the core layer may vary from about 10% to about 90% by weight of the core layer, more particularly from about 20% to about 80% by weight, e.g., about 30% to about 70% by weight of the core layer 105. The particular size and/or orientation of the fibers used may depend, at least in part, on the thermoplastic material used and/or the desired properties of the core layer 105. For example, the reinforcing fibers can be randomly oriented or may have a specific selected orientation as desired. In one non-limiting illustration, reinforcing fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. Where reinforcing fibers are present in combination with reproduced polymeric fibers, the total fiber content in the core layer 105 may vary from about 10% to about 90% by weight of the core layer, more particularly from about 20% to about 80% by weight of the core layer, e.g., about 30% to about 70% by weight of the core layer 105.

In some embodiments, the core layer can include only recycled thermoplastic material (no virgin thermoplastic material) and only reproduced fibers (no virgin fibers). Such articles meet sustainability requirements by including large amounts of recycled thermoplastic and reproduced polymeric fibers. In other embodiments as noted below, the core layer can include multiple core layers stacked together with one or more layers comprising recycled thermoplastic material and reproduced fibers and one or more layers comprising virgin thermoplastic material and virgin fibers.

In certain configurations, one or more biomaterials, which can be present in particle form, fiber form or both can be present with the reproduced fibers. For example, the biomaterials can be produced from one or more of rice hulls, coconuts shells, coffee chaff, wheat hulls, corn hulls, wood particles, coffee bean grounds, plant byproducts and combinations thereof. In some embodiments, bioparticles can be produced from one or more of rice hulls, coconuts shells, coffee chaff, wheat hulls, corn hulls, wood particles, coffee bean grounds, plant byproducts and combinations thereof. In other embodiments, biofibers can be produced from one or more of rice hulls, coconuts shells, coffee chaff, wheat hulls, corn hulls, wood particles, coffee bean grounds, plant byproducts and combinations thereof. In other embodiments, the biomaterials can be produced from egg shells, animal hair, animal bone, animal fat, animal meat, animal collagen, or other animal products and byproducts and combinations thereof. In some embodiments, bioparticles can be produced from egg shells, animal hair (wool, hair), insect secretions (e.g., silk), animal bone, animal fat, animal meat, animal collagen, or other animal products and byproducts and combinations thereof. In other embodiments, biofibers can be produced from one or more of egg shells, seashells, crab shell, shrimp shell, fish shell, animal hair, animal bone, animal fat, animal meat, animal collagen, or other animal products and byproducts and combinations thereof. In some examples, the biomaterials can be produced from non-plant and non-animal products and byproducts including insects, fungus, arthropods, nematodes and combinations thereof. For example, bioparticles can be produced from non-plant and non-animal products and byproducts including insects, fungus, arthropods, nematodes and combinations thereof. In certain examples, biofibers can be produced from non-plant and non-animal products and byproducts including insects, fungus, arthropods, nematodes and combinations thereof. As noted herein, the biomaterials may be present as fibrous biomaterials, particle biomaterials, powder biomaterials or take other forms.

In some embodiments, other additives or materials may also be present in the core layer 105. Such additives may be virgin additive or recycled additives. For example, a lofting agent, flame retardants, colorants, smoke suppressants, surfactants, foams or other materials may be present. In some examples, the core layer 105 may substantially halogen free or halogen free core layer to meet the restrictions on hazardous substances requirements for certain applications. In other instances, the core layer may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 105 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 15 weight percent, e.g., about 5 weight percent to about 15 weight percent based on the weight of the core layer. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 15 weight percent, e.g., about 5 weight percent to about 15 weight percent based on the weight of the core layer. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the core layer 105 is formed. In some examples, the flame retardant material may comprise one or more of expandable graphite materials, magnesium hydroxide (MDH) and aluminum hydroxide (ATH).

In some embodiments, a lofting capacity of the core layer 105 can be tuned by including one or more added lofting agents in the core layer 105. The exact type of lofting agent used in the core layer 105 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kurcha Corp. (Japan). In other examples, the lofting agent may be an expandable graphite material or a combination of a microsphere lofting agent with a non-microsphere lofting agent.

In some configurations, a fiber reinforced thermoplastic composite article 200 can include the porous core layer 105 in combination with a skin layer 210 as shown in FIG. 2. The skin layer 210 may comprise a single layer of material or multiple layers of different materials as desired. In some embodiments, the skin layer 210 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the skin layer 210 may comprise natural fibers, polymeric fibers, reproduced polymeric fibers, biomaterials as described herein or other materials. In other instances, the skin layer 210 may comprise a limiting oxygen index greater than about 22, as measured per ISO 4589 dated 1996. Where a thermoplastic film is present as (or as part of) the skin layer 210, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. The film can include virgin materials, recycled materials or both. Where a fiber based scrim is present as (or as part of) the skin layer 210, the fiber based scrim may comprise at least one of glass fibers, aramid fibers, graphite fibers, carbon fibers, inorganic mineral fibers, metal fibers, metalized synthetic fibers, and metalized inorganic fibers. The fiber based scrim can include virgin materials, recycled materials or both. Where a thermoset coating is present as (or as part of) the skin layer 210, the coating may comprise at least one of unsaturated polyurethanes, vinyl esters, phenolics and epoxies. The thermoset coating can include virgin materials, recycled materials or both. Where an inorganic coating is present as (or as part of) the skin layer 210, the inorganic coating may comprise minerals containing cations selected from Ca, Mg. Ba, Si, Zn, Ti and Al or may comprise at least one of gypsum, calcium carbonate and mortar. The inorganic coating can include virgin materials, recycled materials or both. Where a non-woven fabric is present as (or as part of) the skin layer 210, the non-woven fabric may comprise a thermoplastic material, a thermal setting binder, inorganic fibers, metal fibers, metallized inorganic fibers and metallized synthetic fibers. The non-woven fabric can include virgin materials, recycled materials or both. In some configurations, the skin layer 210 may comprise reproduced polymeric fibers that are also present in the core layer 105. For example, the particular reproduced polymeric fibers in the core layer 105 may be the same as the reproduced polymeric fibers in the skin layer 210. Where the skin layer 210 comprises reproduced polymeric fibers, the reproduced polymeric fibers in the skin layer 210 can include one or more of reproduced polyethylene terephthalate fibers, reproduced polyethylene fibers, reproduced polypropylene fibers, reproduced polyamide fibers, reproduced nylon fibers, reproduced co-polyamide fibers, reproduced high density polyethylene fibers, and combinations thereof. In some configurations, the fibers may comprise reproduced glass fibers, e.g., glass fibers which have been recycled and/or reclaimed with optional physical and/or chemical treatment prior to reuse. The exact amount of reproduced polymeric fibers in the skin layer 210 may vary from about 5% by weight to about 90% by weight, more particularly about 5% by weight to about 80% by weight, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts.

In some embodiments, an adhesive layer (not shown) may optionally be present between the skin layer 210 and the core layer 105. In instances where an adhesive is desirable, one or more thermoplastic polymer adhesives may be used. For example, it may be desirable to couple the skin layer 210 to the core layer 105 using an adhesive. In some examples, the thermoplastic component of the adhesive layer may comprise a thermoplastic polymer such as, for example, a polyamide, a co-polyamide or a polyolefin such as a polyethylene or a polypropylene. The thermoplastic component of the adhesive layer can include recycled thermoplastic materials if desired. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof. In certain embodiments, the adhesive can also include recycled materials and/or reproduced fibers as desired.

In other configurations, a fiber reinforced thermoplastic composite article 300 can include the porous core layer 105 in combination with a skin layer 210 and a skin layer 320 as shown in FIG. 3. The skin layers 210, 320 can be the same or can be different. In certain embodiments, the skin layers 210, 320 may have common materials but different thicknesses or porosities. In some configurations, at least one of the skin layers 210, 320 comprises natural fibers, biomaterials or reproduced polymeric fibers. In other configurations, each of the skin layers 210, 320 comprises natural fibers or reproduced polymeric fibers. If desired, at least one of the skin layers 210, 320 can include both of natural fibers and reproduced polymeric fibers. In some instances, one or both of the skin layers can include recycled thermoplastic materials.

In certain embodiments, the skin layer 320 may comprise a single layer of material or multiple layers of different materials as desired. In some embodiments, the skin layer 320 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the skin layer 320 may comprise natural fibers, polymeric fibers, reproduced polymeric fibers as described herein or other materials. In other instances, the skin layer 320 may comprise a limiting oxygen index greater than about 22, as measured per ISO 4589 dated 1996. Where a thermoplastic film is present as (or as part of) the skin layer 320, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. The film can include virgin materials, recycled materials or both. Where a fiber based scrim is present as (or as part of) the skin layer 320, the fiber based scrim may comprise at least one of glass fibers, aramid fibers, graphite fibers, carbon fibers, inorganic mineral fibers, metal fibers, metalized synthetic fibers, and metalized inorganic fibers. The fiber based scrim can include virgin materials, recycled materials or both. Where a thermoset coating is present as (or as part of) the skin layer 320, the coating may comprise at least one of unsaturated polyurethanes, vinyl esters, phenolics and epoxies. The thermoset can include virgin materials, recycled materials or both. Where an inorganic coating is present as (or as part of) the skin layer 320, the inorganic coating may comprise minerals containing cations selected from Ca, Mg. Ba, Si, Zn, Ti and Al or may comprise at least one of gypsum, calcium carbonate and mortar. The inorganic coating can include virgin materials, recycled materials or both. Where a non-woven fabric is present as (or as part of) the skin layer 320, the non-woven fabric may comprise a thermoplastic material, a thermal setting binder, inorganic fibers, metal fibers, metallized inorganic fibers and metallized synthetic fibers. The non-woven fabric can include virgin materials, recycled materials or both. In some configurations, the skin layer 320 may comprise reproduced polymeric fibers that are also present in the core layer 105. For example, the particular reproduced polymeric fibers in the core layer 105 may be the same as the reproduced polymeric fibers in the skin layer 320. Where the skin layer 320 comprises reproduced polymeric fibers, the reproduced polymeric fibers in the skin layer 320 can include one or more of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

In certain embodiments, an adhesive layer (not shown) may optionally be present between the skin layer 320 and the core layer 105. The adhesive layer may comprise recycled thermoplastic materials if desired. In instances where an adhesive is desirable, one or more thermoplastic polymer adhesives may be used. For example, it may be desirable to couple the skin layer 320 to the core layer 105 using an adhesive. In some examples, the thermoplastic component of the adhesive layer may comprise a thermoplastic polymer such as, for example, a polyamide, a co-polyamide or a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

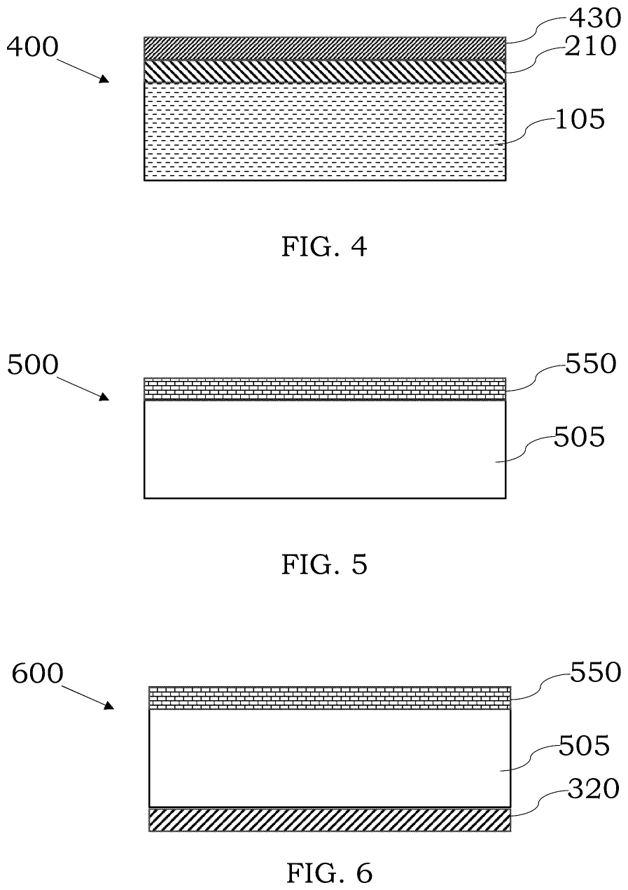

In certain configurations, a fiber reinforced thermoplastic composite article 400 can include the porous core layer 105 in combination with a skin layer 210 and a decorative layer 430 as shown in FIG. 4. The decorative layer 430 can be disposed directly on the porous core layer 105 or a skin layer may be present between the decorative layer 430 and the porous core layer 105 as desired. In certain embodiments, the decorative layer 430 may be formed, e.g., from a thermoplastic film of polyvinyl chloride, polyolefins, thermoplastic polyesters, thermoplastic elastomers, paper, or the like. The film can include virgin materials, recycled materials or both. The decorative layer 430 may also be a multi-layered structure if desired. For example, a fabric may be bonded to a foam core (or other structures), such as woven fabrics made from natural and synthetic fibers, organic fiber non-woven fabric after needle punching or the like, raised fabric, knitted goods, flocked fabric, or other such materials. The fabric may also be bonded with a thermoplastic adhesive, including pressure sensitive adhesives and hot melt adhesives, such as polyamides, modified polyolefins, urethanes and polyolefins. The decorative layer 430 may also be produced using spunbond, thermal bonded, spun lace, melt-blown, wet-laid, and/or dry-laid processes. In some embodiments, the decorative layer 430 may be embossed, textured or otherwise include some pattern or grain structure. If desired, the decorative layer can include reproduced fibers, biomaterials, recycled thermoplastic material or other materials.

In some embodiments, an adhesive layer (not shown) may optionally be present between the decorative layer 430 and the core layer 105. In instances where an adhesive is desirable, one or more thermoplastic polymer adhesives may be used. For example, it may be desirable to couple the decorative layer 430 to the core layer 105 using an adhesive. In some examples, the thermoplastic component of the adhesive layer may comprise a thermoplastic polymer such as, for example, a polyamide, a co-polyamide, or a polyolefin such as a polyethylene or a polypropylene. The adhesive layer may comprise recycled thermoplastic materials if desired. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

In other embodiments, a fiber reinforced thermoplastic composite article can include a porous core layer that is free of any reproduced polymeric fibers in combination with a skin layer that includes reproduced polymeric fibers. An illustration is shown in FIG. 5 where a thermoplastic composite article 500 comprises a skin layer 550 on a surface of porous core layer 505. The porous core layer 505 comprises a web of open celled structures comprising random crossing over of the plurality of non-reproduced polymeric fibers held together by a thermoplastic material. The core layer 505 is typically porous, e.g., is a porous core layer, with a porosity that can vary from less than 0% up to about 95%. For example, the porous core layer 505 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges.

In certain embodiments, the thermoplastic material of the porous core layer 505 can include polyolefin and/or non-polyolefin materials, which may be virgin thermoplastic materials, recycled thermoplastic materials or both. For example, the thermoplastic material of the core layer 505 comprises one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer 505 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer 505 can vary and illustrative amounts range from about 20% by weight to about 80% by weight, e.g., 30-70 percent by weight or 35-65 percent by weight, based on the total weight of the core layer 505. It will be recognized by the skilled person that the weight percentages of all materials used in the core layer 505 will add to 100 weight percent. The thermoplastic material can include only virgin material, only recycled material, or a combination of a virgin material and recycled material. Where a combination of virgin and recycled thermoplastic material are used, The recycled material can be chemically the same or different than the virgin material. Where the recycled material is chemically the same as the virgin material, the recycled material may be physically different than the virgin material, e.g., the recycled material may have a different color, particle size, shape, average glass transition temperature, crystallinity or other physical characteristics that are different than the virgin thermoplastic material even though the virgin thermoplastic material and the recycled thermoplastic material share the same underlying chemistry.

In certain embodiments, the porous core layer 505 can include non-reproduced polymeric fibers or reinforcing fibers that are non-reproduced polymeric fibers, e.g., inorganic fibers, virgin polymeric fibers, etc. As noted herein, the core layer 505 is free of reproduced polymeric fibers. For example, the non-reproduced reinforcing fibers in the core layer 505 may comprise glass fibers, carbon fibers, graphite fibers, synthetic organic fibers, particularly high modulus organic fibers such as, for example, para- and meta-aramid fibers, nylon fibers, polyester fibers, natural fibers, a high melt flow index resin (e.g., 100 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some configurations, the fibers may comprise reproduced glass fibers, e.g., glass fibers which have been recycled and/or reclaimed with optional physical and/or chemical treatment prior to reuse. In certain embodiments, the fibers used may be cellulose free to avoid or reduce the likelihood of mold or other microbial growth. In some embodiments, the fibers in the core layer 505 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material, the reproduced polymeric fibers or both. The reinforcing fiber content in the core layer 505 may vary from about 10% to about 90% by weight of the core layer, more particularly from about 20% to about 80%, e.g., about 30% to about 70%, by weight of the core layer 505. The particular size and/or orientation of the fibers used may depend, at least in part, on the thermoplastic material used and/or the desired properties of the core layer 505. For example, the reinforcing fibers can be randomly oriented or may have a specific selected orientation as desired. In one non-limiting illustration, reinforcing fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. Where reinforcing fibers are present in combination with reproduced polymeric fibers, the total fiber content in the core layer 105 may vary from about 10% to about 90% by weight of the core layer, more particularly from about 20% to about 80%, e.g., about 30% to about 70%, by weight of the core layer 505.

In some embodiments, other additives or materials may also be present in the core layer 505. For example, a lofting agent, flame retardants, colorants, smoke suppressants, surfactants, foams or other materials may be present. In some examples, the core layer 505 may substantially halogen free or halogen free core layer to meet the restrictions on hazardous substances requirements for certain applications. In other instances, the core layer may comprise a halogenated flame retardant agent such as, for example, a halogenated flame retardant that comprises one of more of F. Cl. Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 505 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer 505), more particularly about 1 weight percent to about 15 weight percent, e.g., about 5 weight percent to about 15 weight percent based on the weight of the core layer 505. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer 505), more particularly about 1 weight percent to about 15 weight percent, e.g., about 5 weight percent to about 15 weight percent based on the weight of the core layer 505. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer 505), more particularly about 1 weight percent to about 15 weight percent, e.g., about 2 weight percent to about 14 weight percent based on the weight of the core layer 505. The flame retardant agents used in the layers described herein can be added to the mixture comprising the thermoplastic material and fibers (prior to disposal of the mixture on a wire screen or other processing component) or can be added after the core layer 505 is formed. In some examples, the flame retardant material may comprise one or more of expandable graphite materials, magnesium hydroxide (MDH) and aluminum hydroxide (ATH).

In some embodiments, a lofting capacity of the core layer 505 can be tuned by including one or more added lofting agents in the core layer 505. The exact type of lofting agent used in the core layer 505 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kurcha Corp. (Japan). In other examples, the lofting agent in the core layer 505 may be an expandable graphite material or a combination of a microsphere lofting agent with a non-microsphere lofting agent.

In certain configurations, the skin layer 550 on the core layer 505 can include a plurality of reproduced polymeric fibers and/or biomaterials. For example, the reproduced polymeric fibers in the skin layer 505 can include one or more of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof. The exact amount of reproduced polymeric fibers in the skin layer 550 may vary from about 5% by weight to about 90% by weight, more particularly about 5% by weight to about 80% by weight, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts. Fibers other than reproduced polymeric fibers may also be present in the skin layer 550. For example, the skin layer 550 may be configured as a fiber based scrim that can include reproduced polymeric fibers optionally in combination with non-reproduced polymeric fibers. In certain embodiments, the skin layer 550 comprising the reproduced polymeric fibers may comprise one or more of a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 505. In some examples, the skin layer 550 may also comprise natural fibers, polymeric fibers, or other materials as described herein. In other instances, the skin layer 550 may comprise a limiting oxygen index greater than about 22, as measured per ISO 4589 dated 1996. Where a thermoplastic film is present as part of the skin layer 550, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin layer 550, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as part of the skin layer 550, the coating may comprise at least one of unsaturated polyurethanes, vinyl esters, phenolics and epoxies. Where an inorganic coating is present as part of the skin layer 550, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 550, the non-woven fabric may comprise a thermoplastic material, a thermal setting binder, inorganic fibers, metal fibers, metallized inorganic fibers and metallized synthetic fibers.

In certain configurations, an optional adhesive layer (not shown) may be present between the skin layer 550 and the core layer 505. In instances where an adhesive is desirable, one or more thermoplastic polymer adhesives may be used. For example, it may be desirable to couple the skin layer 550 to the core layer 505 using an adhesive. In some examples, the thermoplastic component of the adhesive layer may comprise a thermoplastic polymer (which can be virgin or recycled) such as, for example, a polyamide, a co-polyamide or a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

In certain embodiments, the core layer 505 and skin layer 550 comprising the reproduced polymeric fibers can be used in combination with a skin layer 320 to provide a composite article 600 as shown in FIG. 6. The skin layer 320 in FIG. 6 may comprise any of those materials described herein in reference to the skin layer 320 shown in FIG. 3. Further, an optional adhesive layer can be present between the skin layer 320 and the core layer 505 if desired. The adhesive layer can include any of those materials noted herein in connection with the optional adhesive layer between the skin layer 550 and the core layer 505.

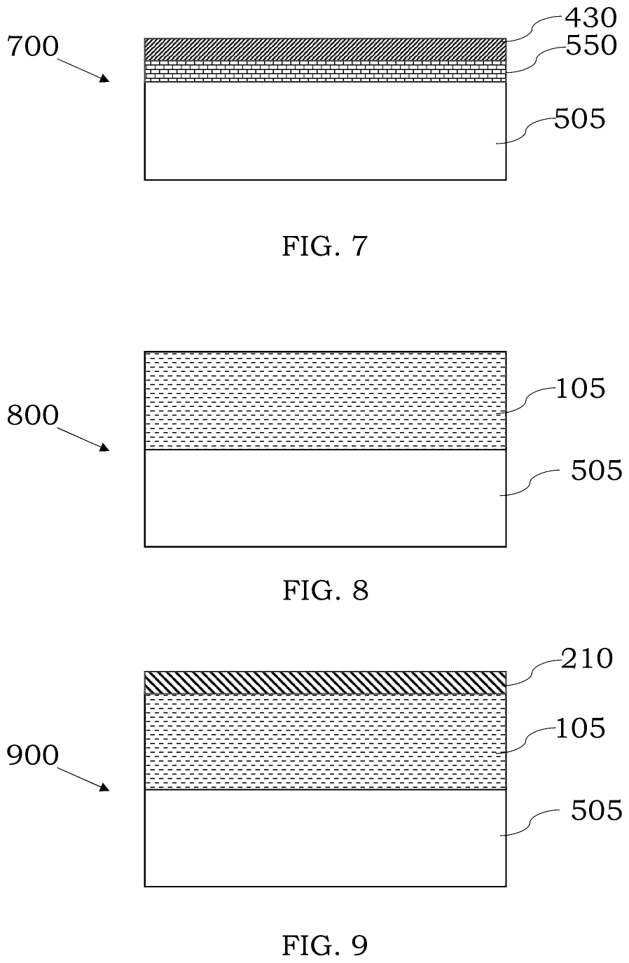

In other embodiments, the core layer 505 and the skin layer 550 comprising the reproduced polymeric fibers can be used in combination with a decorative layer 430 to provide a composite article 700 as shown in FIG. 7. The decorative layer 430 in FIG. 7 may comprise any of those materials described herein in reference to the decorative layer 430 shown in FIG. 4. Further, an optional adhesive layer can be present between the decorative layer 430 and the skin layer 550 if desired. The adhesive layer can include any of those materials noted herein in connection with the optional adhesive layer between the skin layer 550 and the core layer 505.

In certain configurations, a porous core layer with reproduced polymeric fibers can be coupled to a porous core layer without any reproduced polymeric fibers. An illustration is shown in FIG. 8, where a thermoplastic composite article 800 comprises a porous core layer 105 comprising reproduced polymeric fibers and a porous core layer 505 without any reproduced polymeric fibers. The porous core layers 105, 505 can include any of those materials described herein in reference to FIGS. 1 and 5, respectively. If desired, an optional adhesive layer can be used to couple the porous core layer 105 to the porous core layer 505. For example, where an adhesive is used, one or more thermoplastic polymer adhesives may be used. For example, it may be desirable to couple the core layer 105 to the core layer 505 using an adhesive. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

In an alternative arrangement, the core layers of FIG. 8 could instead include similar fibers, e.g., virgin and/or reproduced polymeric fibers, but the thermoplastic materials in the core layers 105, 505 can be different. For example, the layer 505 can include recycled thermoplastic material, and the layer 105 can include virgin thermoplastic material (or vice versa). The fibers in the layers 105, 505 can be the same or can be different as desired.

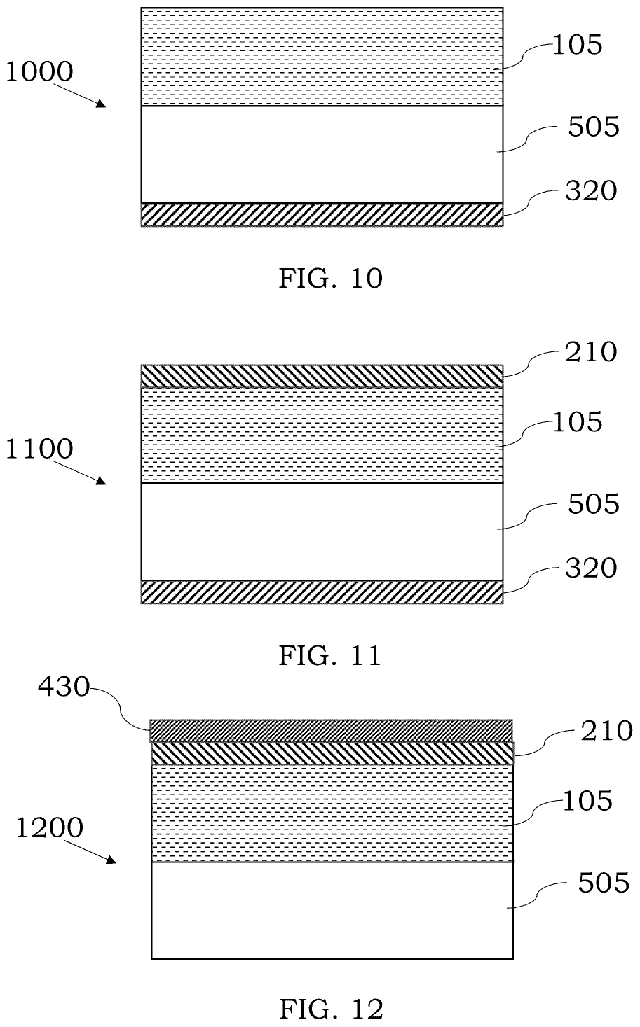

In certain configurations, the coupled core layers 105, 505 can be used in combination with a skin layer 210 (FIG. 9) to provide a thermoplastic composite article 900. The coupled core layers 105, 505 can be used in combination with a skin layer 320 (FIG. 10) to provide a thermoplastic composite article 1000. Skin layers 210, 320 may both be present to provide a composite article 1100 as shown in FIG. 11. In other instances, the coupled core layer 105, 505 can be used with a decorative layer 430 to provide a composite article 1200 as shown in FIG. 12. Another skin (not shown) could be disposed on a surface of the core layer 505 in FIG. 12.

While the core layers 105, 505 are different in FIGS. 8-12, if desired, two or more core layer of the same type could be coupled. For example, two core layers each of which has the composition of the core layer 105 could be coupled. Alternatively, two core layers each of which has the composition of the core layer 505 could be coupled.

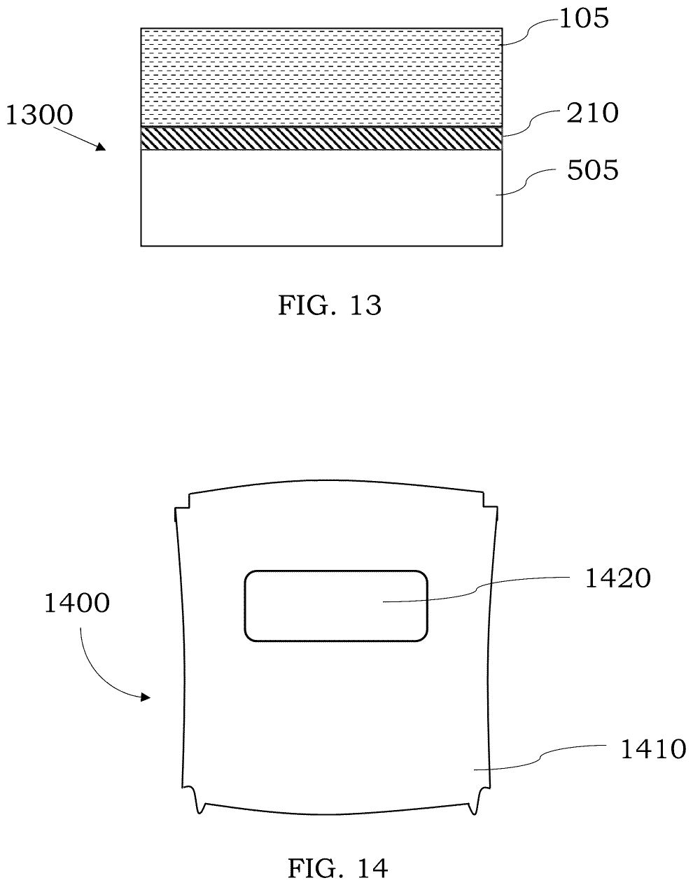

In certain embodiments, a skin layer can be present between two different core layers. Referring to FIG. 13, a composite article 1300 is shown that comprises a skin layer 210 present between a core layer 105 and a core layer 505. An optional adhesive layer can be present between any two of the components as noted herein. Alternatively, the skin layer 210 itself may function to couple the core layer 105 to the core layer 505.

In certain embodiments, where multiple core layers are used together, one or more of the core layers can include recycled thermoplastic materials as noted herein. If desired, each core layer can include recycled thermoplastic materials. In some embodiments, one of the core layers can include recycled thermoplastic materials in combination with reproduced fibers, and the other core layer can include virgin thermoplastic material in combination with reproduced fibers or non-reproduced fibers or both. In another embodiment, one of the core layers can include recycled thermoplastic materials in combination with non-reproduced fibers, and the other core layer can include virgin thermoplastic material in combination with reproduced fibers or non-reproduced fibers or both. Other variations where at least one core layer includes one or more of recycled thermoplastic materials, reproduced fibers, and/or non-reproduced fibers are also possible. While not required, core layers with virgin thermoplastic material can be placed closer to outer surfaces of the article and core layers with recycled thermoplastic material can be placed further away from outer surfaces of the article.

In certain embodiments, any one or more of the core layers described herein may be configured as (or used in) a glass mat thermoplastic composite (GMT) or a light weight reinforced thermoplastic (LWRT). The areal density of such a GMT or LWRT can range from about 200 grams per square meter (gsm) of the GMT or LWRT to about 4000 gsm, although the areal density may be less than 200 gsm or greater than 4000 gsm depending on the specific application needs. In some embodiments, the upper density can be less than 4000 gsm.

In certain examples, one or more of the core layers described herein can be generally prepared using chopped fibers (reinforcing fibers or reproduced polymeric fibers or both), a thermoplastic material (virgin, recycled or both), optionally a lofting agent and/or other materials. For example, a thermoplastic material (virgin, recycled or both) and any fibers can be added or metered into a dispersing foam contained in an open top mixing tank fitted with an impeller. If desired, separate tanks can be used for virgin thermoplastic materials and recycled thermoplastic materials to permit adjustment of the exact amounts of each material in the final article. Without wishing to be bound by any particular theory, the presence of trapped pockets of air of the foam can assist in dispersing the fibers and the thermoplastic material. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web comprising the fibers and the thermoplastic material. The wet web can be passed through a dryer at a suitable temperature to reduce moisture content and to melt or soften the thermoplastic material. The skin layers, decorative layers, etc. can then be applied to the web optionally using an adhesive material between the web and the other layers. The assembly can be passed through one or more sets of rollers to pressure the skins into the web and/or compress the assembly to a desired thickness. The resulting thermoplastic composite article can be cut, sized or otherwise subjected to post-production steps as desired. The machine direction of the process generally refers to the direction of the moving wire screen, whereas the cross direction refers to a direction orthogonal to the machine direction. As noted herein, if desired, the reinforcing fibers, reproduced polymeric fibers or both can be randomly oriented or oriented at a specific angle with respect to the machine direction. It may be desirable to orient reproduced polymeric fibers in a skin layer to have an angle of orientation of 30 degrees, 45 degrees, 60 degrees, 75 degrees or 90 degrees relative to the machine direction.

In certain configurations, the fiber reinforced thermoplastic composite articles described herein can be produced by adding a plurality of reinforcing fibers (e.g., a plurality of non-reproduced polymeric fibers), a plurality of reproduced polymeric fibers and a thermoplastic material (virgin, recycled or both) to an agitated aqueous foam to form a dispersed mixture. The dispersed mixture of the plurality of reinforcing fibers, the reproduced polymeric fibers and the thermoplastic material can be deposited onto a forming support element, e.g., a moving wire screen or other element. Liquid can be evacuated from the deposited, dispersed mixture to form a web. The web, for example, may comprise the fibers which are held in place by the thermoplastic material. The web can be heated above a softening temperature of the thermoplastic material. This softening temperature can vary depending on the nature of the different thermoplastic materials that may be present. The heated web can be compressed to a selected or predetermined thickness, e.g., 500 microns to about 20 mm, more particularly about 1 mm to about 10 mm or about 2 mm to about 8 mm. A skin layer can be disposed on the compressed web to provide the thermoplastic composite article. Alternatively, a skin layer can be disposed on the web prior to compression and the resulting thermoplastic composite article can be compressed to a desired overall thickness. As noted herein, the skin layer may or may not include reproduced polymeric fibers as desired.

In certain embodiments, the core layers, skin layers and/or the thermoplastic composite articles described herein can be used to produce interior components or parts or exterior components or parts. For example, the thermoplastic composite article may be present in a vehicular panel, a vehicular underbody panel, an exterior automotive part, an interior automotive part, an automotive headliner, a recreational vehicle panel or a recreational vehicle part.

In certain configurations, the core layers, skin layers and/or thermoplastic composite articles described herein can be used to provide a vehicle headliner. Illustrative vehicles include, but are not limited to, automotive vehicles, trucks, trains, subways, recreational vehicles, aircraft, ships, submarines, space craft and other vehicles which can transport humans or cargo. In some instances, the headliner typically comprises at least one core layer as described herein and a decorative layer, e.g., a decorative fabric, disposed on the core layer. The decorative layer, in addition to being aesthetically and/or visually pleasing, can also enhance sound absorption and may optionally include foam, insulation or other materials. An illustration of a top view of a headliner is shown in FIG. 14. The headliner 1300 comprises a body 1410 and an opening 1420, e.g., for a sunroof, moonroof, etc., though more than a single opening may be present if desired. The body 1410 of the headliner 1400 can include one or more of the thermoplastic composite articles described herein optionally with decorative layers, fabrics, cloth, etc. The opening 1420 is optional and can be produced by trimming the headliner 1400. The “C” surface or roof side of the headliner typically consists of a non-woven scrim layer for handling purposes. The overall shape and geometry of the headliner 1300 may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle.

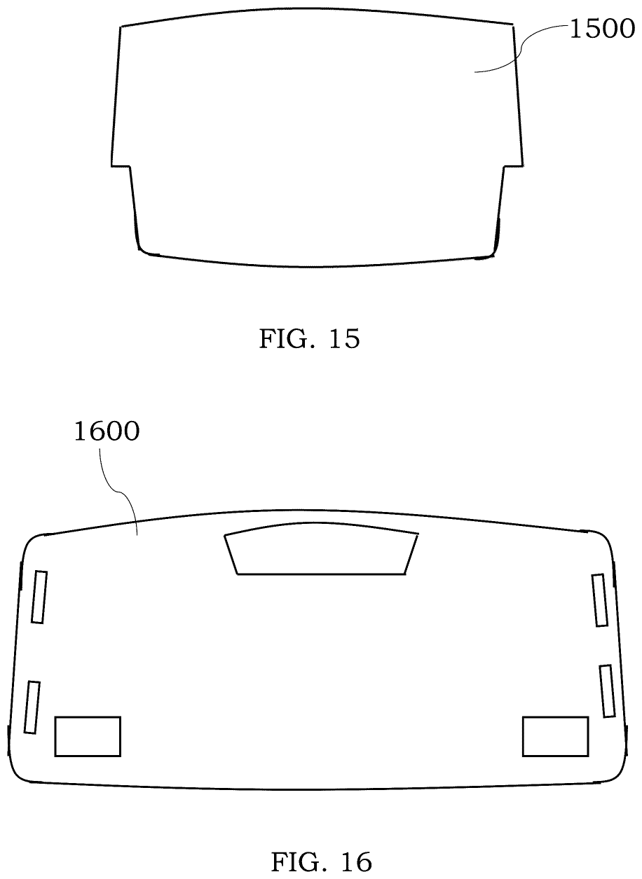

In certain instances, the core layers, skin layers and/or the thermoplastic composite articles described herein can be used to produce underbody shields and rear window trim pieces or parts. An illustration of an underbody shield 1500 is shown in FIG. 15, and an illustration of top view of a rear window trim 1600 is shown in FIG. 16. The particular outer layers used in the underbody shield 1500 and the rear window trim 1600 may be different from the headliner. For example, the underbody shield may comprise a scrim or other outer layer to increase its durability and/or the acoustic characteristics. The inner surface of the underbody shield, e.g., which sits adjacent to the bottom of the engine may comprise one or more layers designed to absorb and/or retain automotive fluids such as motor oil, antifreeze, brake fluid or the like. While various openings are shown in the rear window trim 1600, the positions and geometries of these openings may vary. In addition, typical rear window trim decorative material may comprise a non-backed PET or PP carpet. The underbody shield 1500 and the window trim 1600 may comprise one or more of the core layers and/or thermoplastic composite articles described herein.

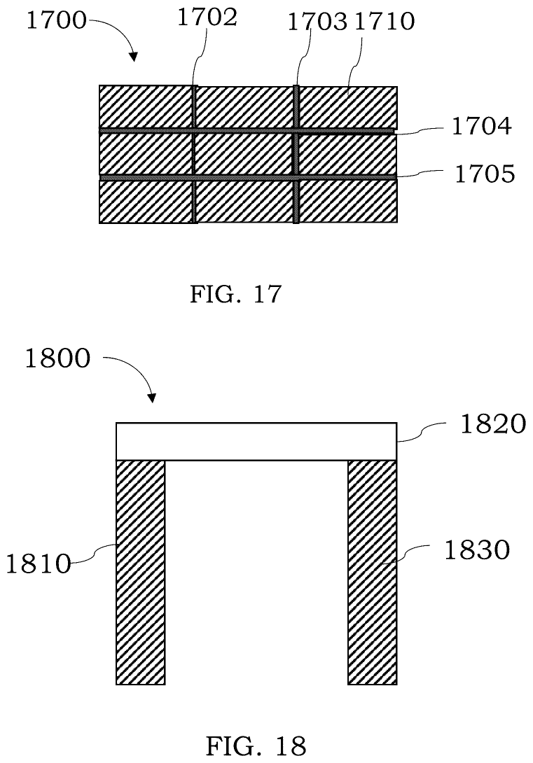

In certain examples, the core layers, skin layers and/or thermoplastic composite articles described herein can be used in composite articles configured for interior use in recreational vehicle panels, wall panels, building panels, roofs, flooring or other applications. As noted herein, the composite articles are generally used in an as-produced state and are not molded. In certain examples, the articles described herein can be configured as a ceiling tile. Referring to FIG. 17, a grid of ceiling tiles 1700 is shown that comprises support structures 1702, 1703, 1704 and 1705 with a plurality of ceiling tiles, such as tile 1710, laid into the grid formed by the support structures. In some examples, the ceiling tile comprises one or more of the core layers, skin layers and/or the thermoplastic composite articles described herein. In some examples, the ceiling tile 1710 may comprise a porous decorative layer, e.g., a fabric, cloth, or other layers, disposed on a porous core layer or a skin layer as described herein.

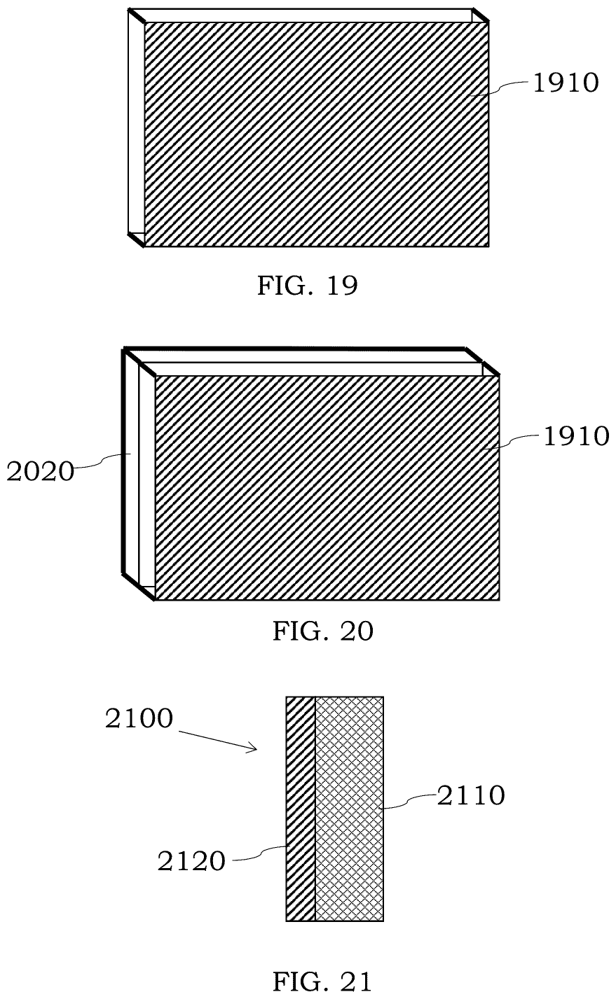

In other embodiments, the core layers, skin layers and/or thermoplastic composite articles described herein can be used in non-automotive or non-RV parts as well. For example, the thermoplastic composite articles can be used in building applications including roofing, flooring, ceiling tiles or panels, cubicle panels, and other building applications. In certain examples, a cubicle panel may comprise one or more of the core layers, skin layers and/or thermoplastic composite articles. Referring to FIG. 18, a top view of a cubicle 1800 comprising side panels 1810, 1830 and center panel 1820 are shown. Any one or more of the panels 1810-1830 may comprise one of the core layers, skin layers and/or thermoplastic composite articles described herein. The cubicle panel may also comprise one or more skin layers. In some examples, the cubicle wall panel is sized and arranged to couple to another cubicle wall panel.

In certain embodiments, the core layers, skin layers and/or thermoplastic composite articles described herein can be present in a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 19, a top view of a structural panel 1910 is shown. The panel 1910 may comprise any one or more of the core layers, skin layers and/or thermoplastic composite articles described herein. If desired, two or more structural panels can be sandwiched with a skin facing into the interior of the room and another skin of the other structural panel facing outward away from the interior of the room. In some instances, the structural panel may also comprise a structural substrate 2020 as shown in FIG. 20. The exact nature of the structural substrate 2020 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. If desired, the structural panel may further comprise a second structural panel coupled to a skin layer of the first structural panel.

In certain instances, the core layers, skin layers and/or thermoplastic composite articles described herein can be present in a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 21, a side view of a wall panel 2100 is shown. The panel 2100 may comprise one or more of the core layers, skin layers and/or thermoplastic composite articles described herein. For example, the wall panel 2100 may also comprise at least one skin 2120 coupled to a first surface of a porous core layer 2110. While not shown, a second skin may be placed on a second surface of the core layer 2110. An optional wall substrate can be coupled to a second surface of the porous core layer 2110 and configured to support the porous core layer 2110 when the wall panel 2100 is coupled to a wall surface. In certain configurations, the wall panel 2100 further comprises a porous decorative layer disposed on the skin 2120. In certain embodiments, a second wall panel can be coupled to the skin 2120.

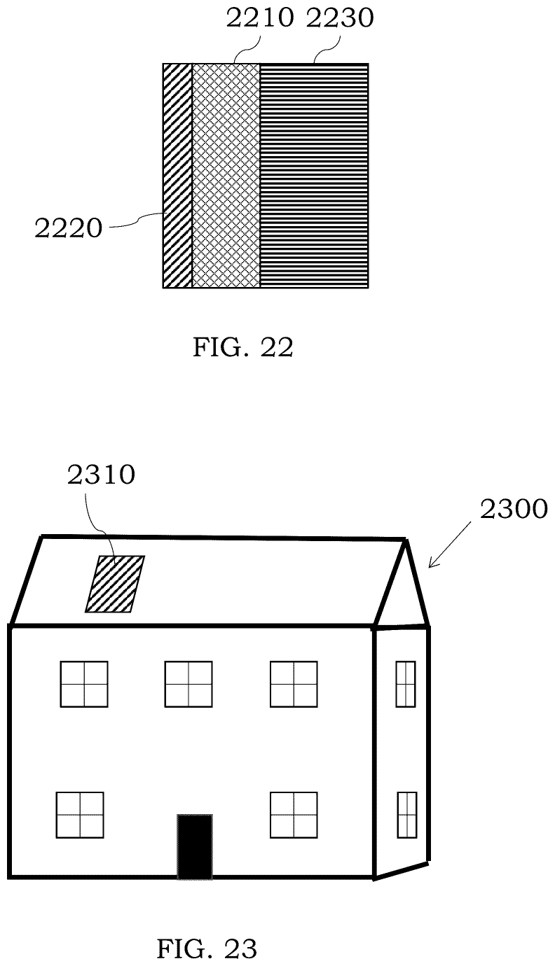

In certain instances, the core layers, skin layers and/or thermoplastic composite articles described herein can be present in a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 22 a side view of a siding panel is shown. The panel may comprise any one or more of the core layers, skin layers and/or thermoplastic composite articles described herein, e.g., a core layer 2210 and a skin 2220. A building substrate 2230 can be configured with many different materials including, but not limited to vinyl, wood, brick, concrete, etc. For example, a vinyl substrate can be coupled to a first surface of the skin 2220, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the siding panel may further comprise a second siding panel and can be coupled to a second substrate. In some cases, a butt joint, overlapping joint, etc. may exist where the two siding panels can horizontally lock into each other.

In certain instances, the core layers, skin layers and/or thermoplastic composite articles described herein can be present in a roofing panel to be attached to a building such as a residential home or a commercial building. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 23, a perspective view of a roofing panel 2310 attached to a house 2300 is shown. The roofing panel 2310 may comprise any one or more of the core layers, skin layers and/or thermoplastic composite articles described herein. If desired, two or more roofing panels can be sandwiched or otherwise used together. The roofing panel may also comprise a roofing substrate coupled to a first surface of a core layer and can be coupled to a roof of a building to retain the roofing panel to the roof. In some examples, the roofing panel may comprise, or be used with, a weather barrier, e.g., a membrane, house wrap, tar paper, plastic film, etc. In certain instances, the roofing panel comprises a second roofing panel or can be overlapped with, or coupled to, a second roofing panel to prevent moisture from entering into the house 2300.

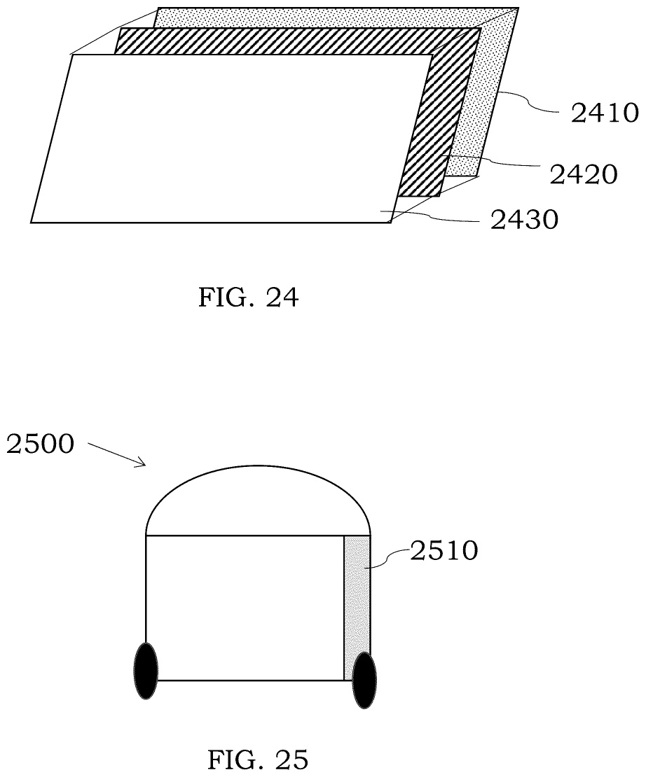

In certain configurations, the core layers, skin layers and/or thermoplastic composite articles described herein can be present in a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 24, an exploded view of a roofing shingle is shown. The roofing shingle 2400 may comprise any one or more of the core layers, skin layers and/or thermoplastic composite articles described herein. If desired, two or more roofing shingles can be sandwiched. In some examples, the roofing shingle may comprise a core layer 2410. If desired, a weatherproof roofing shingle substrate 2430 can be coupled to a first surface and configured to couple to a roofing panel of a building to provide a weatherproof and flame retardant roofing panel. In certain instances, a weather barrier can be coupled to a roofing shingle. In other examples, the roofing shingle comprises asphalt. An intermediate layer 2420, e.g., a skin, insulation or other materials, can be present between the outer layer 2430 and core layer 2410.

In certain configurations, any one or more of the core layers, skin layers and/or thermoplastic composite articles described herein can be present in an interior panel or wall of a recreational vehicle (RV) or an interior panel of an aircraft or aerospace vehicle, e.g., a rocket, satellite, shuttle or other airline or space vehicles. The panel or wall can be used, for example, to cover a skeleton structure on an interior side of the recreational or aerospace vehicle and may be coupled to foam or other insulation materials between the interior and exterior of the vehicle. In some examples, the core layers, skin layers and/or thermoplastic composite articles described herein may be part of a sandwich structure formed from the core layer or article and other layers. If desired, the interior panel can be coupled to another substrate such as, for example, a fabric, plastic, tile, etc.

Referring to FIG. 25, a side view of a recreational vehicle 2500 is shown. The interior panel 2510 may comprise any one or more of the core layers, skin layers and/or thermoplastic composite articles described herein. If desired, two or more RV panels can be sandwiched or coupled together. In some examples, an RV panel may comprise an interior wall substrate that is configured as a decorative layer such as a fabric, a plastic, tile, metal, wood or the like. In additional instances, the RV panel comprises a second RV interior panel which can be the same or different from the RV panel. If desired, the RV panel may comprise a third RV interior panel which may also be the same or different. While not shown, a similar interior panel can be present in aerospace applications/vehicles and may be placed against and/or coupled to an exterior skin such as a metal or metal alloy skin or structure, e.g., aluminum, magnesium, titanium, etc. or other exterior structure.

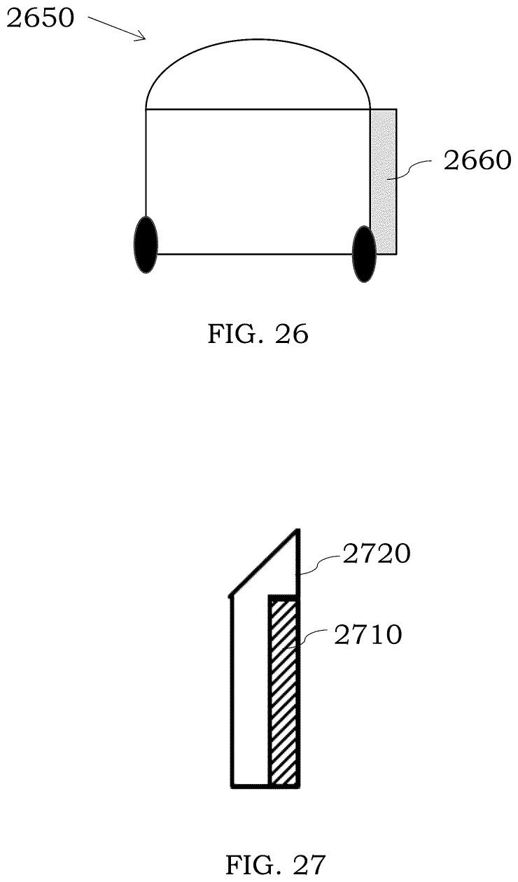

In certain configurations, any one or more of the core layers, skin layers and/or thermoplastic composite articles described herein can be configured as, or present in, an exterior panel or wall of an aircraft vehicle, an aerospace vehicle or a recreational vehicle. The panel or wall can be used, for example, to cover a skeleton structure on an exterior side of the vehicle and may be coupled to foam or other insulation materials between the interior and exterior of the vehicle. In some examples, the core layer or article may be part of a sandwich structure formed from the core layer or article and other layers. If desired, the exterior panel can be coupled to another substrate such as, for example, a metal, a metal alloy, fiberglass, etc. Referring to FIG. 26, a side view of a recreational vehicle 2650 is shown that comprises an exterior panel 2660, which can be configured as any one of the core layers, skin layers and/or thermoplastic composite articles described herein. If desired, two or more RV panels can be sandwiched with a skin facing into the interior of the RV and a skin of the other RV panel facing outward away from the interior of the RV. In certain configurations, the exterior wall substrate comprises glass fibers or is configured as a metal panel such as aluminum or other metal materials. In additional instances, the RV panel comprises a second RV exterior panel which can be the same or different from the RV panel. If desired, the RV panel may comprise a third RV exterior panel which may also be the same or different. While not shown, a similar exterior panel can be present in aerospace applications/vehicles and may be placed against and/or coupled to an interior skin or structure such as an interior metal or metal alloy skin, e.g., aluminum, magnesium, titanium, etc., or other interior structure.

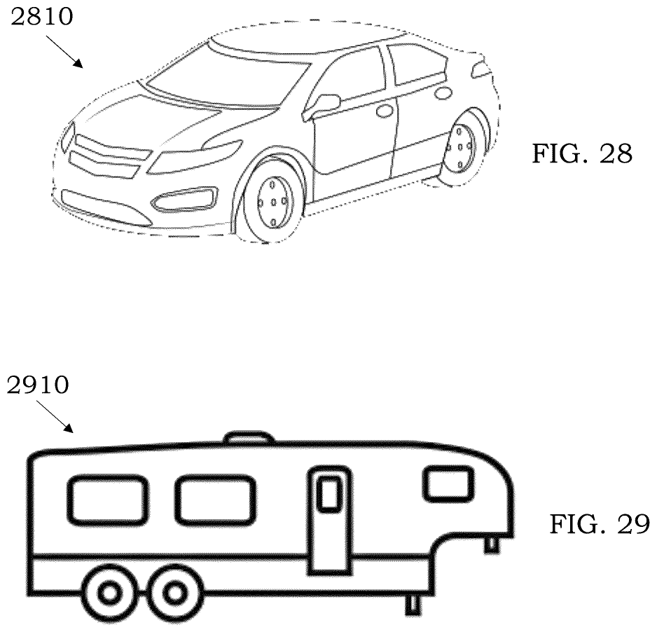

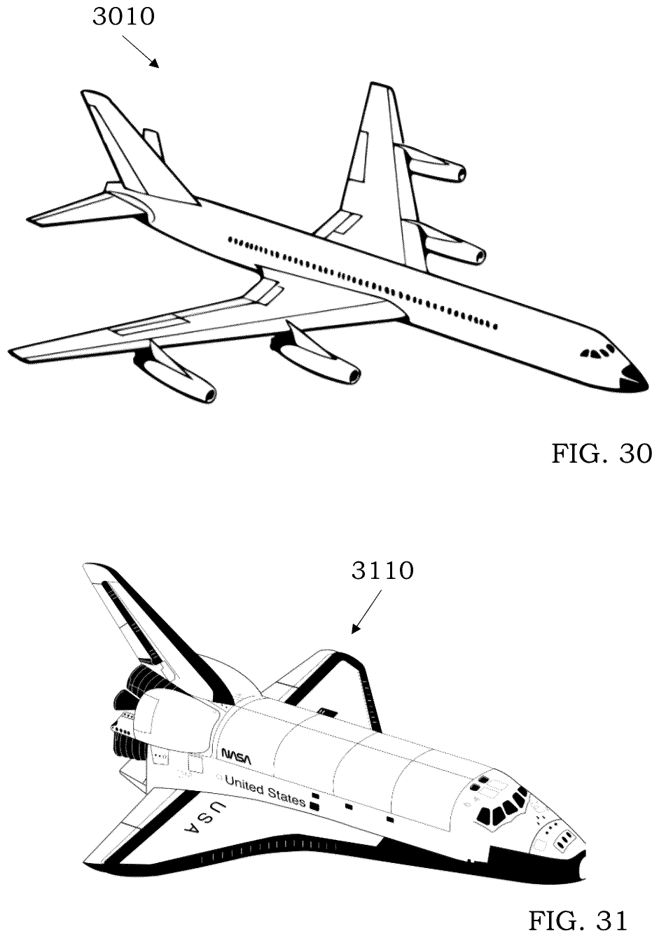

In certain examples, the core layers, skin layers and/or thermoplastic composite articles described herein can be used in an automotive vehicle 2810 (FIG. 28), a recreational vehicle 2910 (FIG. 29), an airplane 3010 (FIG. 30), a shuttle or a spacecraft 3110 (FIG. 31), a rocket, a satellite, or other vehicles which comprise one or more wheels, an engine, a motor, a turbine, a rocket, a fuel cell, a battery, are solar powered, are powered by wind, are gas propelled or have a motive means which can be used to propel the vehicle. As shown in FIG. 29, however, vehicles with the core layers, skin layers and/or thermoplastic composite articles described herein may be towed behind or coupled to another vehicle if desired and may not have an independent motor or engine to propel them.

In some examples, the core layers, skin layers and/or thermoplastic composite articles described herein can be used as interior trim applications, e.g., RV interior trim, interior trim for building or for automotive applications. The interior trim can be coupled to other materials, such as, for example, wood, PVC, vinyl, plastic, leather or other materials. A side view illustration of a trim piece that can be used as baseboard trim is shown in FIG. 27. The trim piece comprises a trim substrate 2720. The trim piece may be nailed or otherwise attached to a stud or wallboard 2710 as desired. The substrate 2720 faces outward and is viewable within a room. The trim piece can be curved or may take two or three dimensional shapes as desired. If desired, one or more decorative skins may be present on an outside of the trim piece and facing into the interior of the room.

Certain specific examples are described to facilitate a better understanding of the technology described herein.

### Example 1

Two composite article formulations were prepared and tested for their mechanical properties. Mechanical properties were measured according to ISO178 dated 2011 (flexural properties) or ISO527 dated 2001 (tensile properties) or equivalent testing methodologies unless otherwise specified. Formulation 1 included 20 weight percent recycled polyolefin resin (mixture of PP and PE), 5 weight percent reproduced polyethylene terephthalate (PET) fibers, 50 weight percent glass fibers and 25 weight percent virgin PP resin. Formulation 2 included 20 weight percent recycled polyolefin resin (mixture of PP and PE), 10 weight percent reproduced PET fibers, 45 weight percent glass fibers and 25 weight percent virgin PP resin. The two formulations were compared to a Superlite (SL) control material that included 45 weight percent glass fibers and 55 weight percent virgin PP.

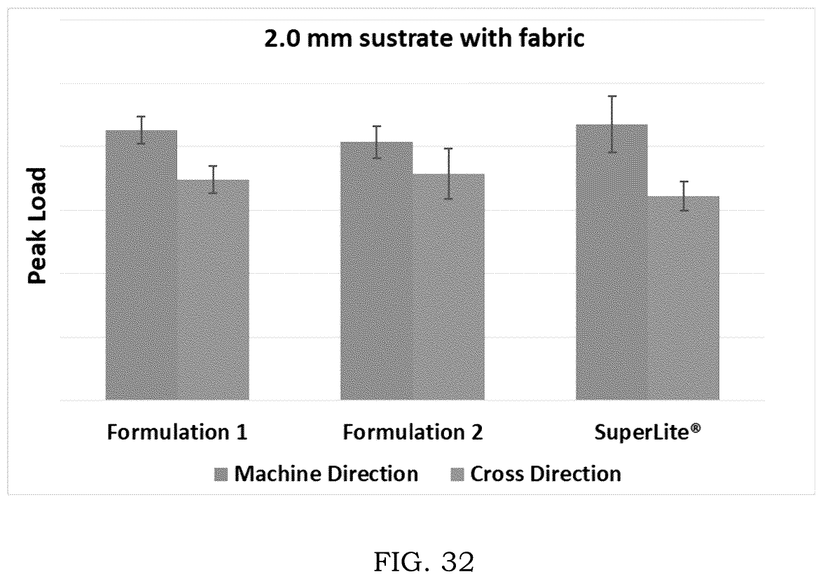

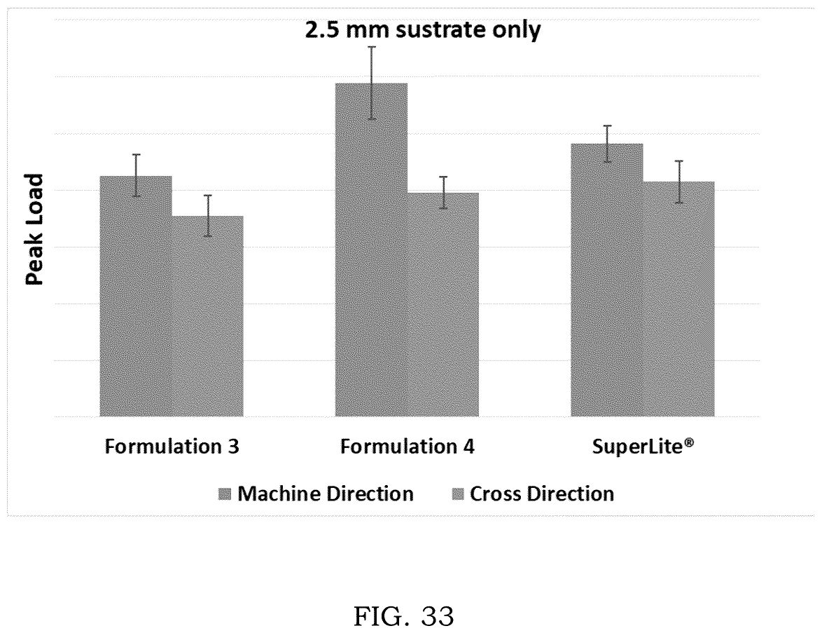

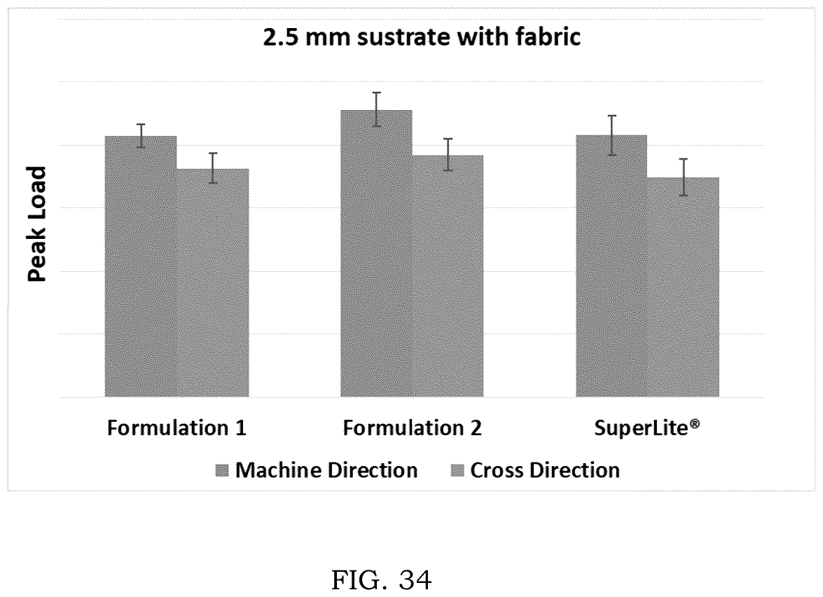

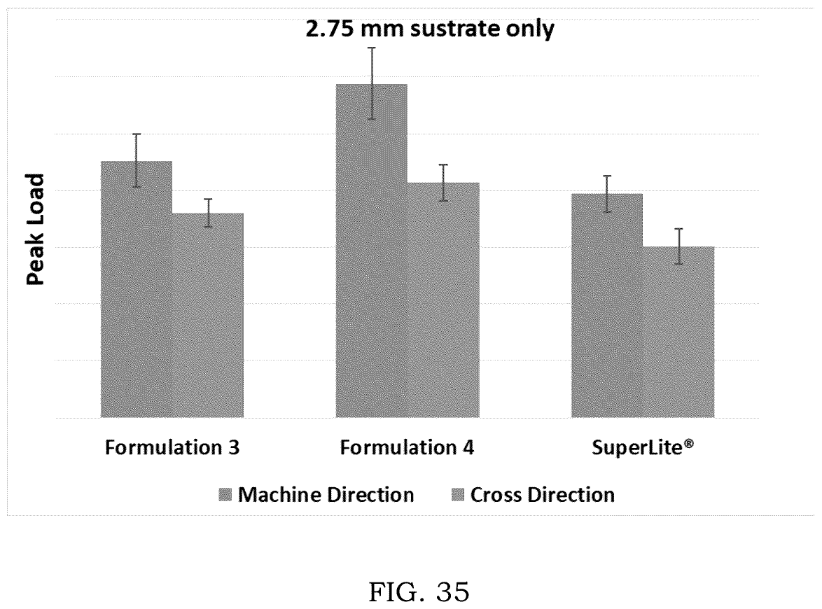

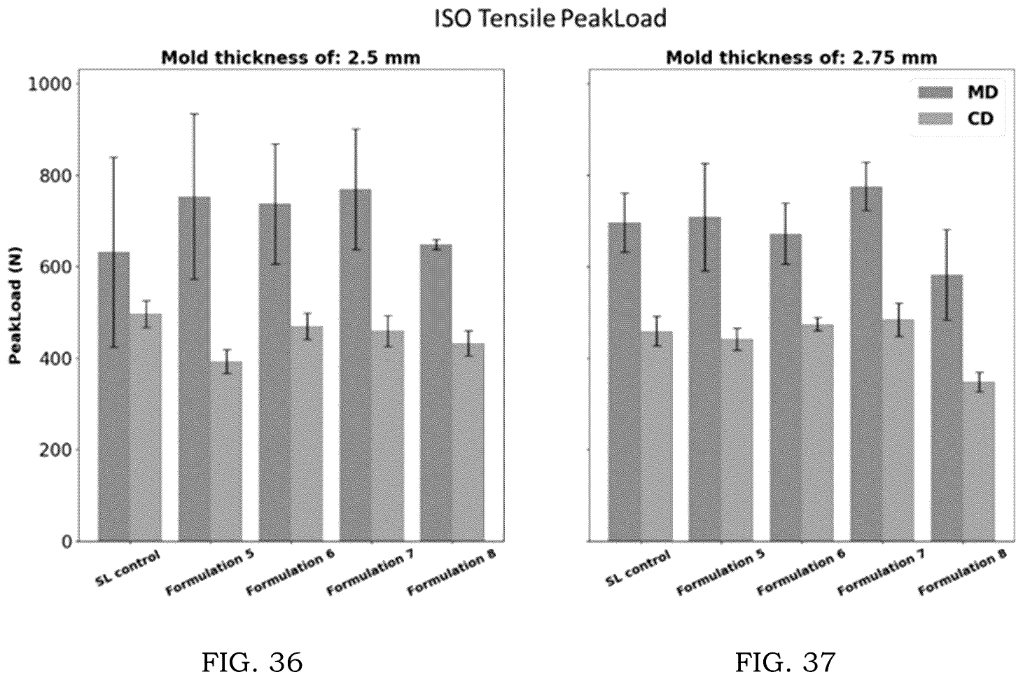

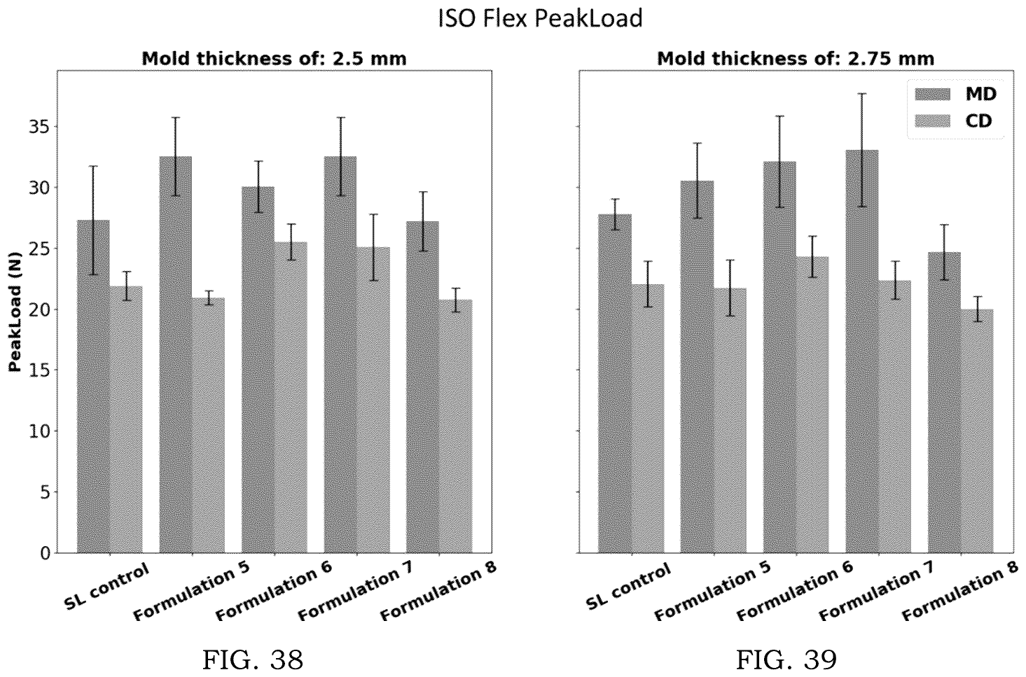

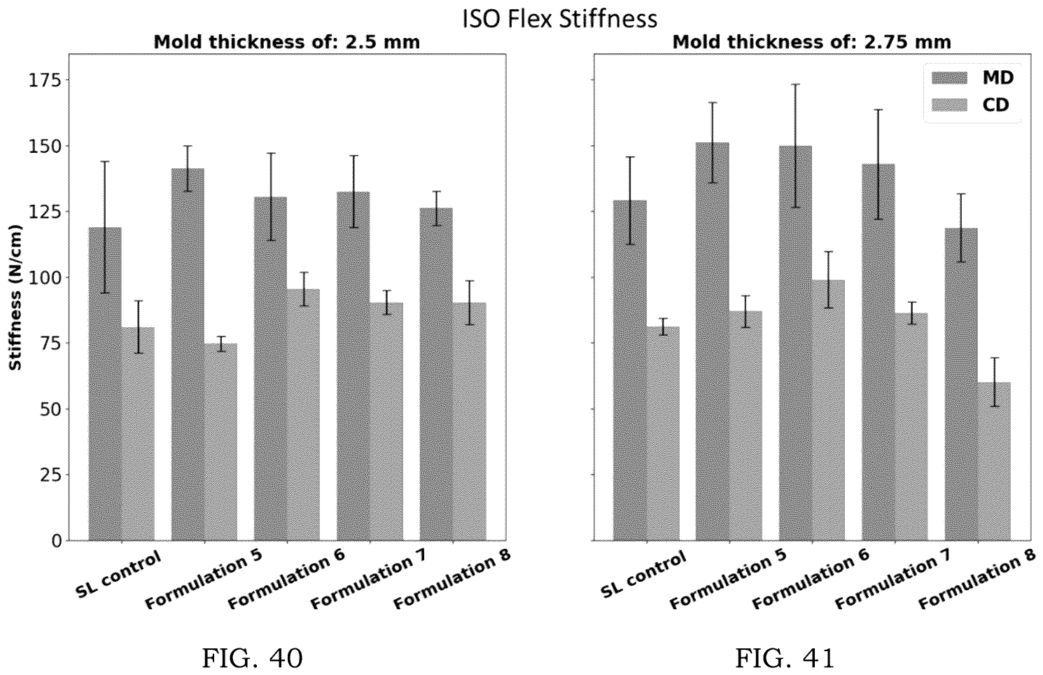

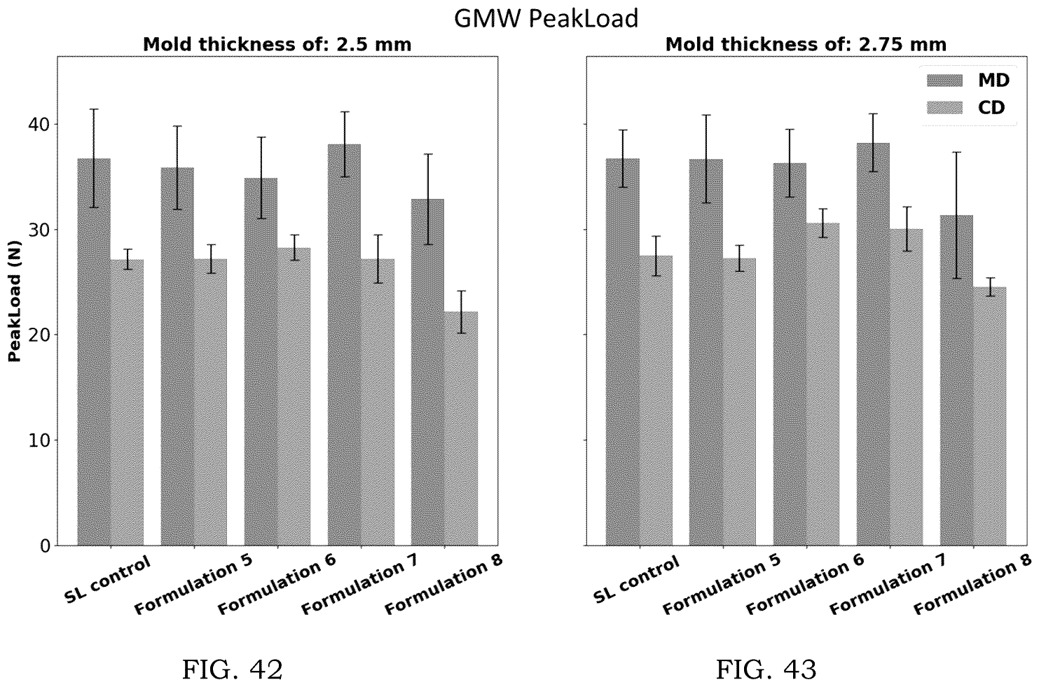

The results of mechanical testing are shown in FIG. 32 and FIG. 33 for different thicknesses. Machine direction refers to the mechanical tests in the direction of the moving support used to produce the articles. Cross direction refers to a direction orthogonal to the machine direction. The results are consistent with the articles including the recycled materials providing similar or better performance than the control material.

### Example 2

Two composite article formulations were prepared and tested for their mechanical properties. Mechanical properties were measured according to ISO178 dated 2011 unless otherwise specified. Formulation 3 included 10 weight percent Kenaf fibers, 45 weight percent glass fibers and 45 weight percent virgin polyolefin resin. Formulation 4 included 20 weight percent Kenaf fibers, 35 weight percent glass fibers and 45 weight percent virgin polyolefin resin. The two formulations were compared to a Superlite control material that included 45 weight percent glass fibers and 55 weight percent virgin polyolefin.

The results of mechanical testing are shown in FIG. 34 and FIG. 35 for different thicknesses. The results are consistent with the articles including the higher loading of Kenaf fibers providing similar or better performance than the control material.

### Example 3

Four composite article formulations were prepared and tested for their mechanical properties. Mechanical properties were measured according to ISO178 dated 2011 (or equivalent methodology such as ASTM D790-17) unless otherwise specified. Formulation 5 included 5% by weight Kenaf fibers, 10% by weight recycled polyolefin resin (mixture of PP and PE), 50% by weight glass fibers and 35% by weight virgin polyolefin resin. Formulation 6 included 5% by weight Kenaf fiber, 20% by weight recycled polyolefin resin (mixture of PP and PE), 50% by weight glass fibers and 25% by weight virgin PP resin. Formulation 7 included 10% by weight Kenaf fiber, 10% by weight recycled polyolefin resin (mixture of PP and PE), 45% by weight glass fibers and 35% by weight virgin PP resin. Formulation 8 included 10% by weight Kenaf fibers, 20% by weight recycled polyolefin resin (mixture of PP and PE), 45% by weight glass fibers and 25% by weight virgin PP resin. The four formulations were compared to a Superlite control material that included 45 weight percent glass fibers and 55 weight percent virgin PP.

The results of mechanical testing are shown in FIGS. 36-43 for different thicknesses. In the machine direction, formulations 5-8 generally had better or similar mechanical properties as the control material. The cross direction mechanical properties varied with the exact amount of materials that were present.

### Example 4

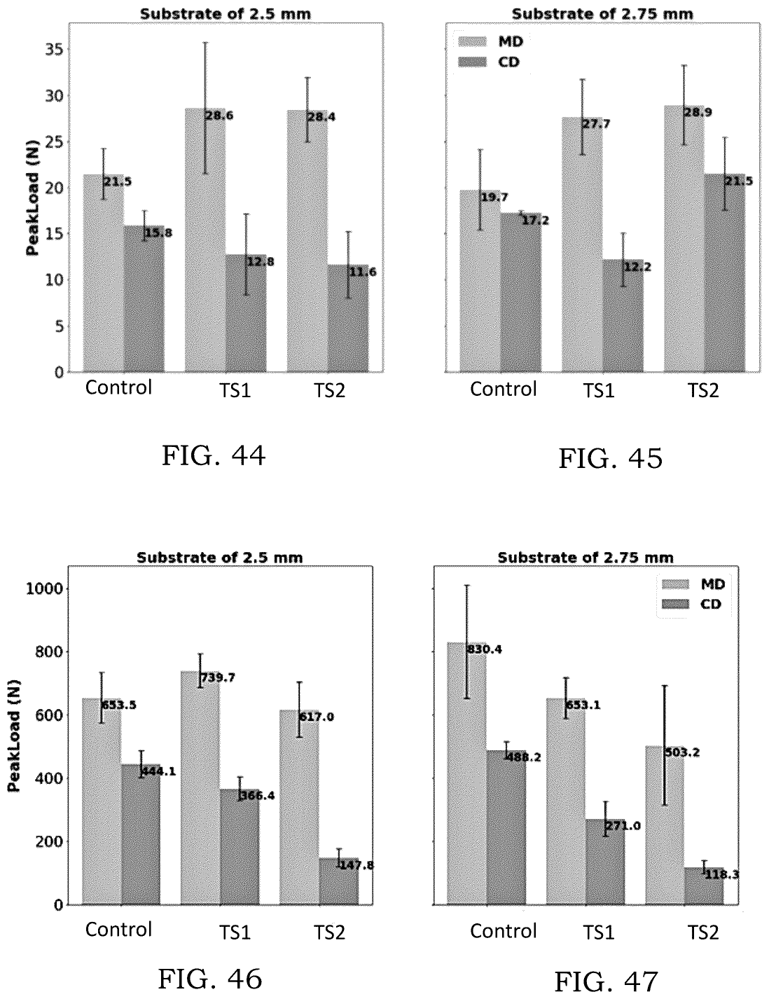

Two test core layers were produced and compared to a control layer (SL control). The SL control includes 55% by weight glass fibers and 45% by weight polypropylene. Test specimen #1 included reproduced polyethylene terephthalate fibers (5% by weight), 50% by weight glass fibers and 45% by weight polypropylene. Test specimen #2 included reproduced polyethylene terephthalate fibers (10% by weight), 45% by weight glass fibers and 45% by weight polypropylene. ISO-Flex Peak load and ISO-Tensile Peak load were tested according to ISO178 dated 2011 (flex) and ISO527 as revised on 2001 (tensile), respectively. Table 1 shows the results of the ISO-flex peak load testing, and Table 2 shows the results of the ISO-Tensile Peak load. Average values are shown in Tables 1 and 2 with the variability shown in FIGS. 44-47. TS stands for test specimen. MD refers to machine direction, CD refers to cross direction and SD refers to standard deviation. In each bar graph grouping, the left bar are the machine direction values and the right bar are the cross direction values.

TABLE 1

| | Mold | | MD | MD_SD | CD | CD_SD |
|---|---|---|---|---|---|---|
| Description | Thickness | | (N) | (N) | (N) | (N) |
| SL control | 2.5 | mm | 21.5 | 2.8 | 15.9 | 1.6 |
| Test Specimen #1 | 2.5 | mm | 28.6 | 7.1 | 12.8 | 4.4 |
| Test Specimen #2 | 2.5 | mm | 28.4 | 3.5 | 11.6 | 3.6 |
| SL control | 2.75 | mm | 19.7 | 4.4 | 17.2 | 0.3 |
| Test Specimen #1 | 2.75 | mm | 27.7 | 4.1 | 12.2 | 2.9 |
| Test Specimen #2 | 2.75 | mm | 28.9 | 4.3 | 21.5 | 4.0 |

TABLE 2

| | Mold | | MD | MD_SD | CD | CD_SD |
|---|---|---|---|---|---|---|
| Description | Thickness | | (N) | (N) | (N) | (N) |
| SL control | 2.5 | mm | 653.5 | 79.6 | 444.1 | 42.7 |
| Test Specimen #1 | 2.5 | mm | 739.7 | 53.4 | 366.4 | 37.7 |
| Test Specimen #2 | 2.5 | mm | 617.0 | 86.8 | 147.8 | 29.1 |
| SL control | 2.75 | mm | 830.4 | 178.9 | 488.2 | 26.6 |
| Test Specimen #1 | 2.75 | mm | 653.1 | 64.7 | 271.0 | 54.8 |
| Test Specimen #2 | 2.75 | mm | 503.2 | 188.2 | 118.3 | 21.1 |

As shown in Table 1 and FIGS. 44 and 45, at a comparable mold thickness, the machine direction values for ISO flex peak load are similar or better than the control values. ISO flex peak load cross direction values tend to be similar or lower than the control values.

As shown in Table 2 and FIGS. 46 and 47, at a comparable mold thickness, the machine direction values for ISO tensile peak load for test specimen #1 are improved at 2.5 mm mold thickness but reduced at 2.75 mm mold thickness. Specimen #2 had reduced tensile peak load in both the machine and cross directions for both mold thicknesses. These results are consistent with reproduced fibers being suitable for use in certain weight percentages and certain mold thicknesses.

### Example 5

Several test specimens were produced that included reproduced PET fibers and/or recycled resin. The specimen formulation are shown in Table 3. GF represents glass fibers, PP represented polypropylene and PET represents polyethylene terephthalate.

TABLE 3

| | Core gsm | |
|---|---|---|
| Formulation | (g/m²) | Color |
| SLcontrol-1 PL0357-PL1: 55% GF + | 1000 | Natural |
| 45% virgin PP resin | | |
| PL0357-PL2: 55% GF + 35% virgin PP resin + | 1000 | Mottled |
| 10% recycled PP resin | | |
| PL0357-PL3: 55% GF + 25% virgin PP resin + | 1000 | Mottled |
| 20% recycled PP resin | | |
| SLcontrol-2 PL0356-PL1: 55% GF + | 1000 | Natural |
| 45% virgin PP resin | | |
| PL0356-PL4: 50% GF + 35% virgin PP resin + | 1000 | Mottled |
| 10% recycled PP resin + 5% reproduced PET fibers | | |
| PL0356-PL5: 50% GF + 25% PP resin + | 1000 | Mottled |
| 20% recycled PP resin + 5% reproduced PET fibers | | |
| PL0356-PL6: 45% GF + 35% virgin PP resin + | 1000 | Mottled |
| 10% recycled PP resin + 10% reproduced PET fibers | | |
| PL0356-PL7: 45% GF + 25% virgin PP resin + | 1000 | Mottled |
| 20% recycled PP resin + 10% reproduced PET fibers | | |

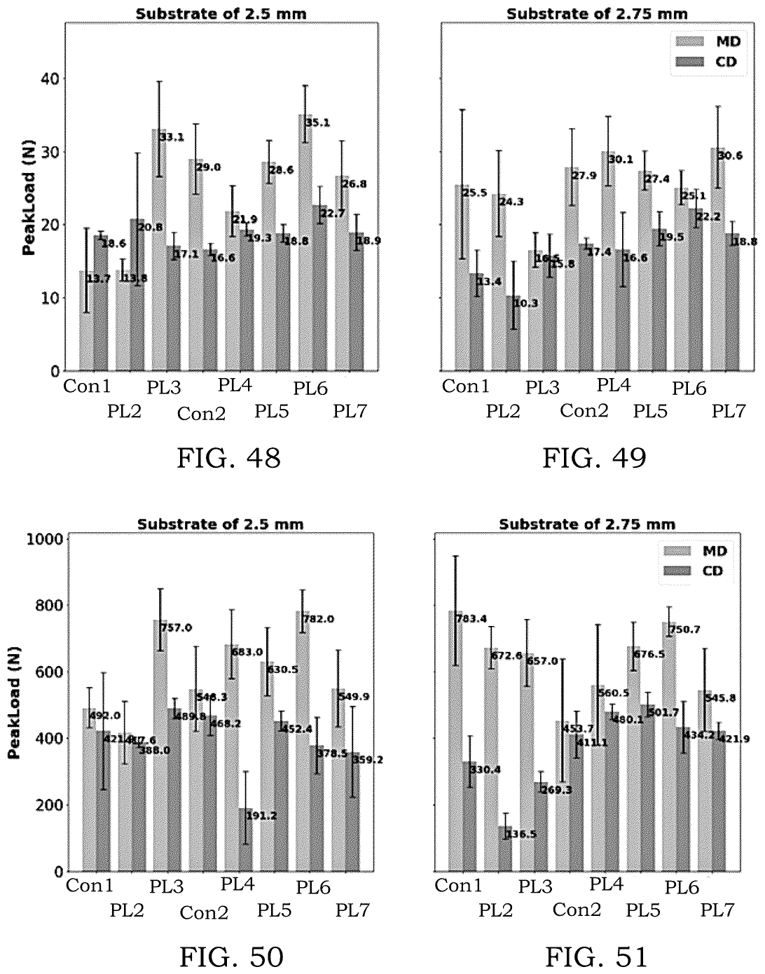

The ISO-flex peak load testing results are shown in FIGS. 48 and 49 for different thicknesses. The ISO-tensile peak load testing results are shown in FIGS. 50 and 51 for different substrate thicknesses. MD refers to machine direction, and CD refers to cross direction. In each bar graph grouping, the left bar are the machine direction values and the right bar are the cross direction values.

The ISO-flex peak load values for the test specimens were similar or comparable to the control values, indicating inclusion of the reproduced fibers and/or recycled resin provides similar or better performance. The ISO-tensile peak load values vary with fiber and resin loading. For example, in tested specimens that included recycled PET fiber, the machine direction values are generally higher than the control specimen values.

### Example 6

Two test specimens were produced which included reproduced Kenaf fibers of different length. The formulations are shown in Table 4 below.

TABLE 4

| | Core | |
|---|---|---|
| | gsm | |
| Formulation | (g/m²) | Color |
| SL control PL0375-PL1: 55% GF + 45% virgin PP resin | 1000 | Natural |
| PL0375-PL2: 45% GF + 45% virgin PP resin + 10% | 1000 | Natural |
| 3 mm Kenaf fiber | | |
| PL0375-PL3: 45% GF + 45% virgin PP resin + 10% | 1000 | Natural |
| 6 mm Kenaf fiber | | |

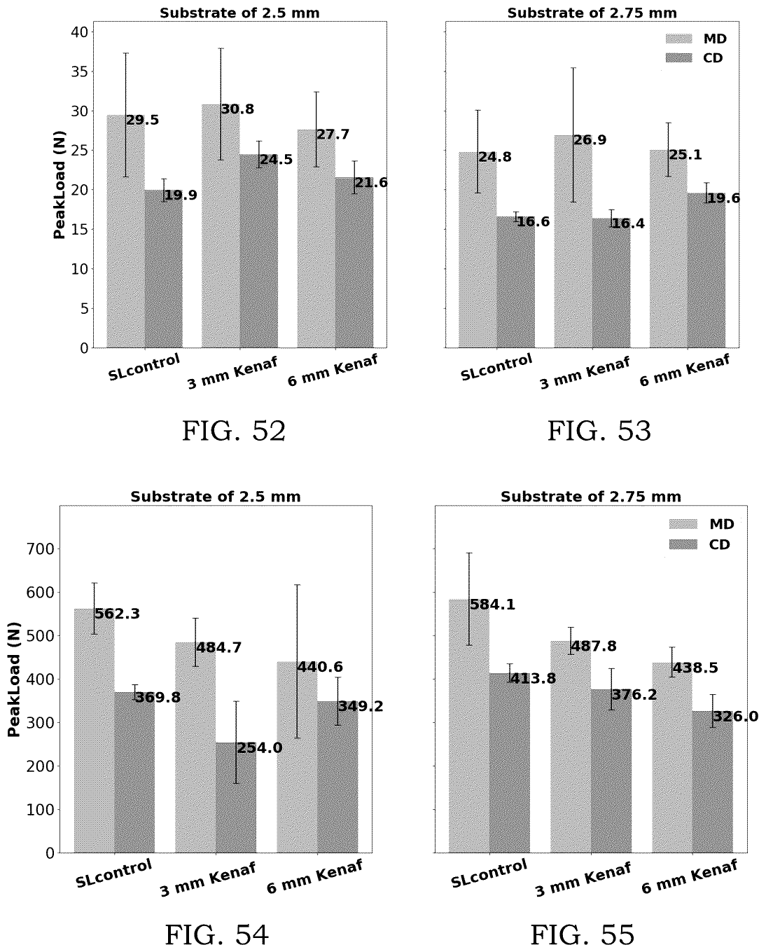

ISO-flex peak load values (FIGS. 52 and 53) and ISO-tensile peak load values (FIGS. 54 and 55) were measured for different substrate thicknesses. In each bar graph grouping, the left bar are the machine direction values and the right bar are the cross direction values.

The ISO-flex peak load values were similar or better than the control values at different thicknesses. The ISO-tensile peak load values were generally lower than control values and decrease with increasing Kenaf fiber length in both the machine and cross directions.

### Example 7

Several test specimens were prepared that included various amounts of recycled PP resin and various skins. The formulations are shown below in Table 5.

TABLE 5

| | Core | | |
|---|---|---|---|
| | gsm | | |
| Formulation | (g/m²) | Skins | Color |
| SL-5151 (control) : 55% GF + | 1000 | 88 gsm film + | Black |
| 45% PP resin | | 20 gsm scrim | |
| ST-14731: 55% GF + 35% virgin PP | 1000 | 98 gsm film + | Black |
| resin + 10% recycled PP resin | | 20 gsm scrim | |
| ST-14732: 55% GF + 25% virgin PP | 1000 | 98 gsm film + | Black |
| resin + 20% recycled PP resin | | 20 gsm scrim | |
| ST-14733: 55% GF + 35% virgin PP | 1100 | 98 gsm film + | Black |
| resin + 10% recycled PP resin | | 20 gsm scrim | |
| ST-14734: 55% GF + 25% virgin PP | 1100 | 98 gsm film + | Black |
| resin + 20% recycled PP resin | | 20 gsm scrim | |

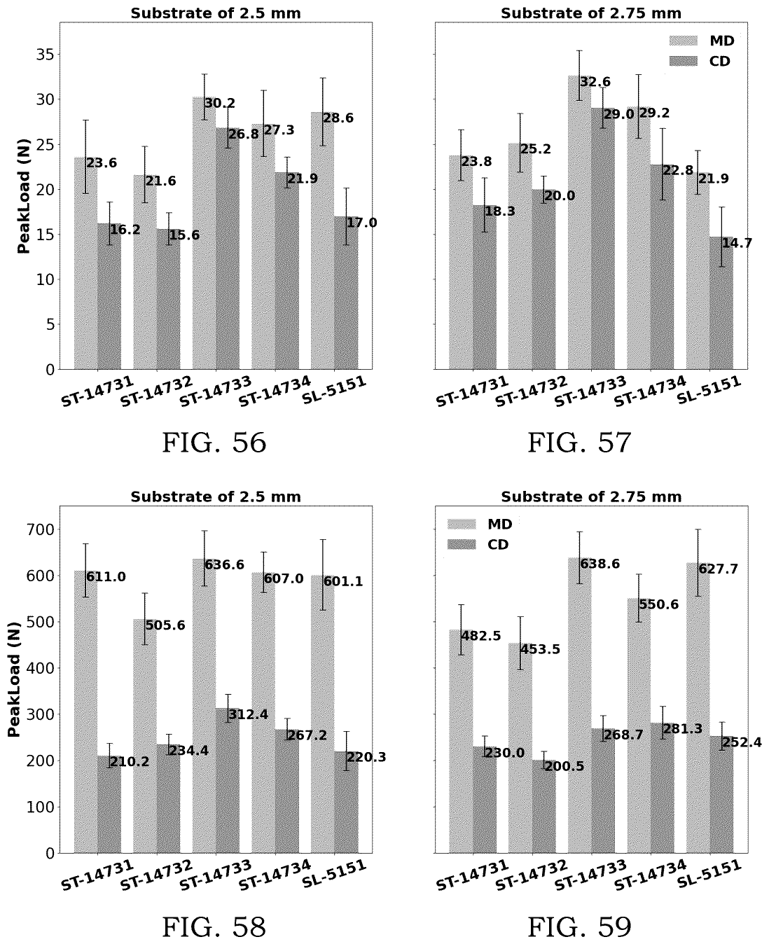

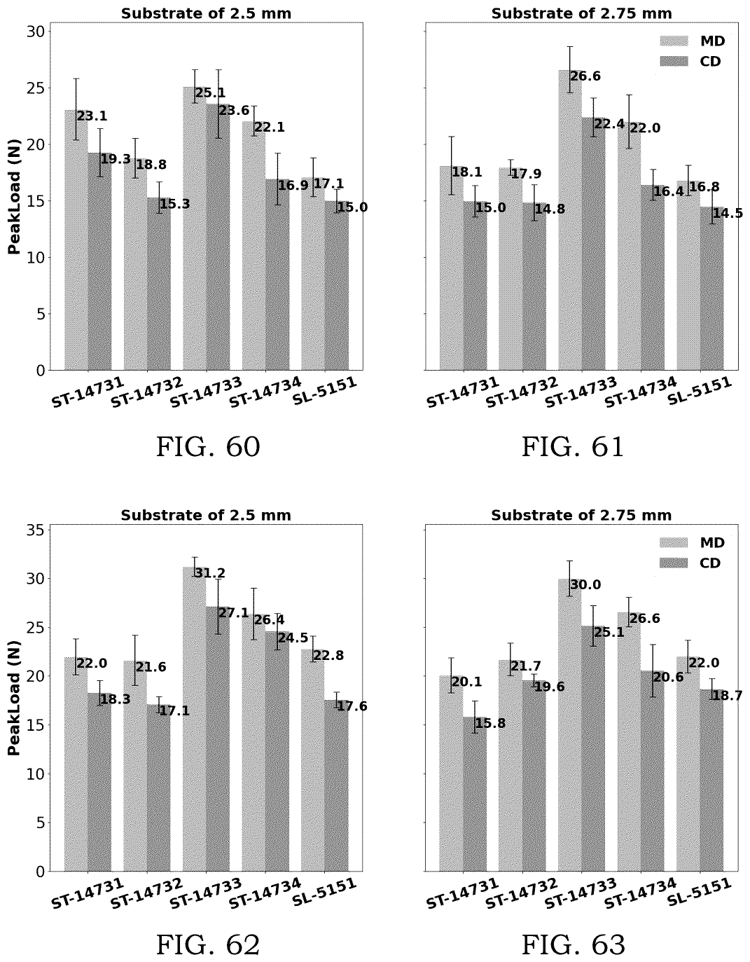

ISO-flex peak load values (FIGS. 56 and 57) and ISO-tensile peak load values (FIGS. 58 and 59) were measured for different substrate thicknesses. FIGS. 60-63 show SAE-flex peak load for substrate only (FIGS. 60 and 61) and for substrate plus attached skins (FIGS. 62 and 63). In each bar graph grouping, the left bar are the machine direction values and the right bar are the cross direction values.

The ISO-flex peak load values were similar (within the standard deviation) or better for the test specimens compared to the control specimen at both substrate thicknesses. The ISO-tensile peak load values for test specimens were similar or lower than the control specimen values for the machine direction. An increase in basis weight of the core layer resulted in an increase in the ISO-tensile peak load values. In the cross direction, the ISO-tensile peak load values were similar as those values for the control values for both substrates.

For SAE-flex peak load values, the test specimen values were similar to or better than control values with higher basis weights (1100 gsm) providing higher values. Addition of the skin layers (FIGS. 62 and 63) increased the SAE-flex peak load values compared to comparable substrate thicknesses without the skin layers.

These results are consistent with recycled PP resin providing similar performance as virgin PP in the core layers.

### Example 8

Several test specimens were prepared that included various amounts of reproduced PET fibers and various skin layers. The formulations are shown below in Table 6.

TABLE 6

| | Core | | |
|---|---|---|---|
| | gsm | | |
| Formulation | (g/m²) | Skins | Color |
| SL-5151 (control) : 55% GF + 45% | 1000 | 88 gsm film + | Black |
| PP resin | | 20 gsm scrim | |
| ST-14780: 45% GF + 45% virgin PP | 1000 | 98 gsm film + | Natural |
| resin + 10% reproduced PET fibers | | 20 gsm scrim | |
| ST-14781: 35% GF + 45% virgin PP | 1000 | 98 gsm film + | Natural |
| resin + 20% reproduced PET fibers | | 20 gsm scrim | |
| ST-14782: 45% GF + 45% virgin PP | 900 | 98 gsm film + | Natural |
| resin + 10% reproduced PET fibers | | 20 gsm scrim | |
| ST-14783: 35% GF + 45% virgin PP | 900 | 98 gsm film + | Natural |
| resin + 20% reproduced PET fibers | | 20 gsm scrim | |

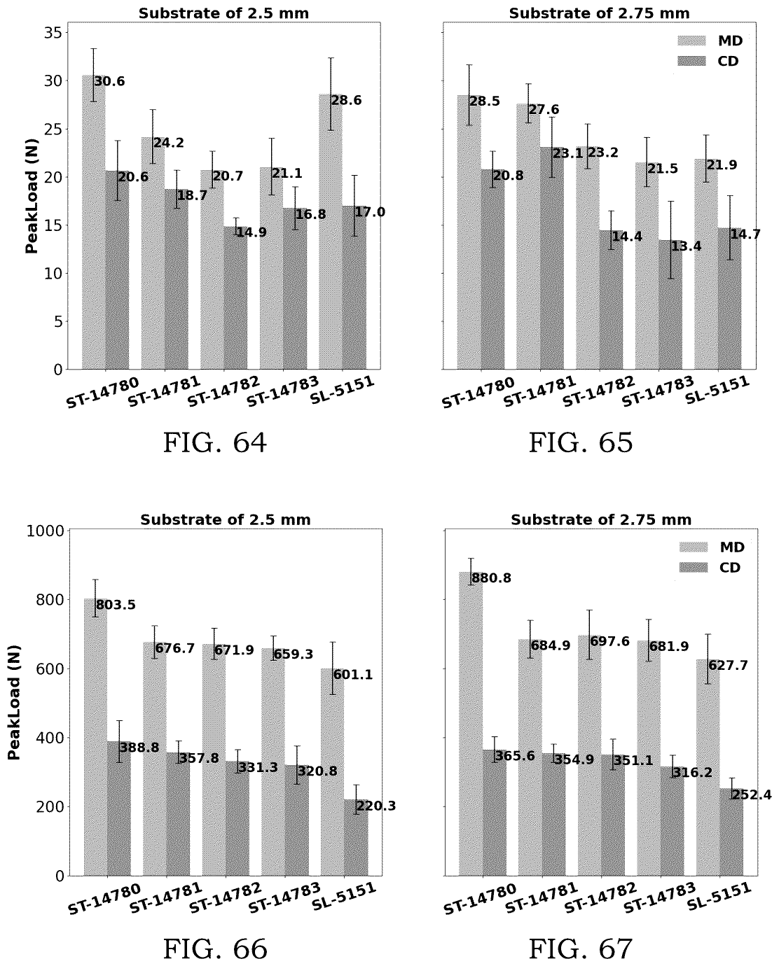

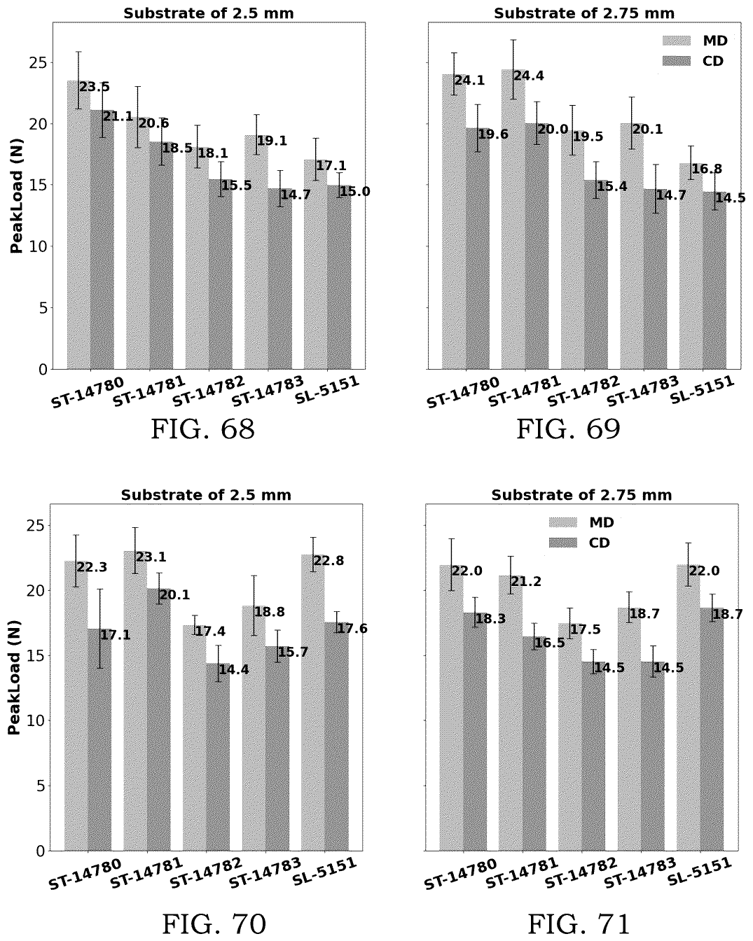

ISO-flex peak load values (FIGS. 64 and 65) and ISO-tensile peak load values (FIGS. 66 and 67) were measured for different substrate thicknesses. FIGS. 68-71 show SAE-flex peak load for substrate only (FIGS. 68 and 69) and for substrate plus attached skins (FIGS. 70 and 71). In each bar graph grouping, the left bar are the machine direction values and the right bar are the cross direction values.

The ISO-flex peak load values generally decreased as the glass fiber loading decreased and as basis weight decreased. A similar trend was observed for ISO-tensile values. The SAE-flex peak values were higher than the control values at a comparable basis weight even at lower glass fiber loading levels. These results are consistent with reproduced PET fibers providing similar performance as core layers with only glass fibers.

### Example 9

Several test specimens were prepared that included various amounts of recycled resin, reproduced PET fibers and various skin layers. The formulations are shown below in Table 7.

TABLE 7

| | Core | | |
|---|---|---|---|
| | gsm | | |
| Formulation | (g/m²) | Skins | Color |
| SL-4062 (control) : 55% GF + 45% | 1000 | 40 gsm film + | Black |
| PP resin | | 17 gsm scrim | |
| SL-3751 (control): 55% GF + 45% | 1000 | 70 gsm film + | Black |
| virgin PP resin | | 20 gsm scrim | |
| ST-14894: 50% GF + 25% virgin PP | 1000 | 60 gsm film + | Black |
| resin + 20% recycled PP resin + 5% | | 20 gsm scrim | |
| reproduced PET fibers | | | |
| ST-14895: 45% GF + 25% virgin PP | 1000 | 60 gsm film + | Black |
| + 20% recycled PP resin + 10% | | 20 gsm scrim | |
| reproduced PET fibers | | | |

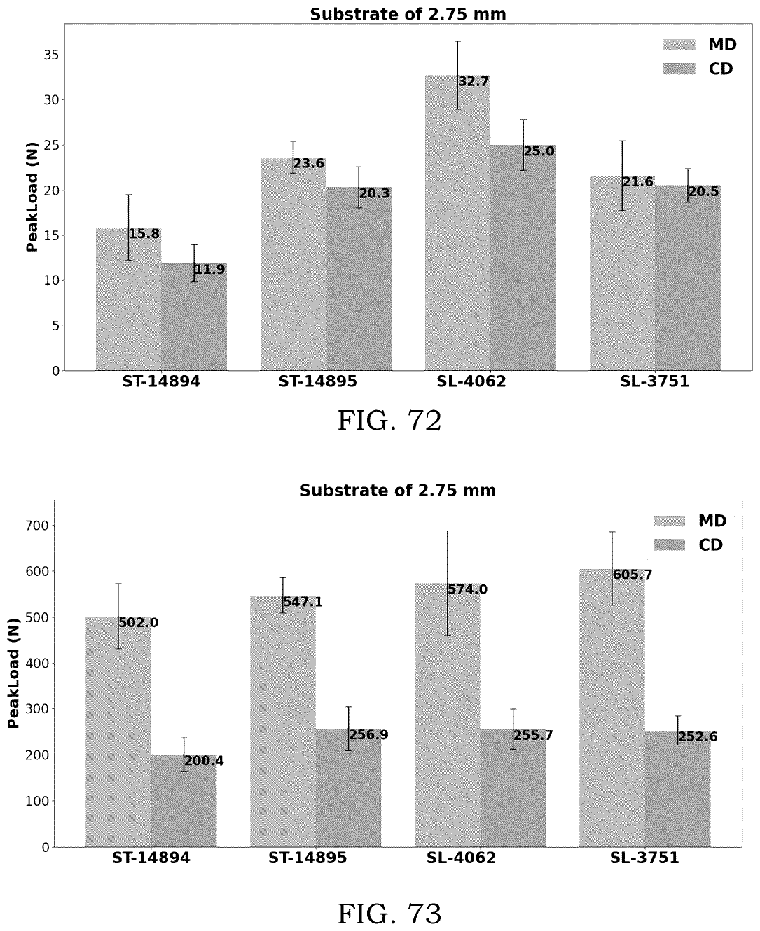

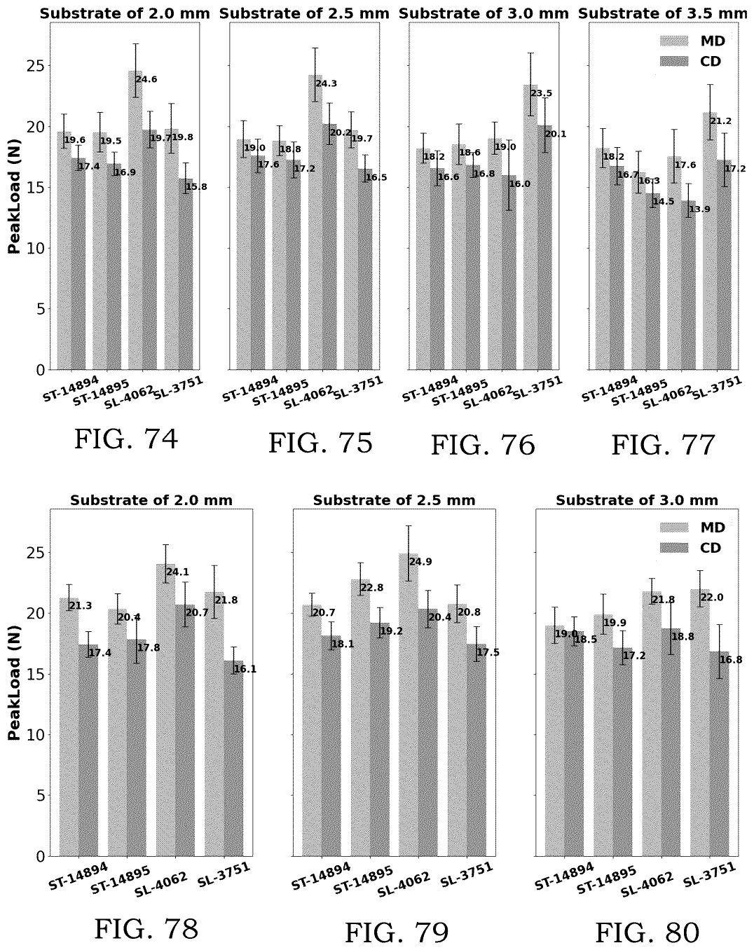

ISO-flex peak load values (FIG. 72) and ISO-tensile peak load values (FIG. 73) were measured for a substrate thickness of 2.75 mm. FIGS. 74-77 show SAE-flex peak load for substrate only, and FIGS. 78-80 show SAE-flex peak load values for substrate plus attached skins at different substrate thicknesses. In each bar graph grouping, the left bar are the machine direction values and the right bar are the cross direction values.

The ISO-flex peak load and ISO-tensile peak load values were slightly lower for the test specimens compared to the control values in the machine direction. The ISO-flex peak load values and the ISO-tensile peak load values in the cross direction were comparable at higher reproduced PET fiber loading compared to the control values. The SAE-flex peak values were also lower than the control values at a comparable substrate thickness. Addition of the skins (FIGS. 78-80) increased the SAE-flex values slightly. These results are consistent with recycled resin and reproduced fibers providing comparable performance as core layers with only glass fibers and virgin resin.

### Example 10

Several test specimens were prepared that included various amounts of recycled resin and/or reproduced PET fibers and various skin layers. The formulations are shown below in Table 8.

TABLE 8

| | Core | | |
|---|---|---|---|
| | gsm | | |
| Formulation | (g/m²) | Skins | Color |
| SL-4062 (control) : 55% GF + | 1000 | 40 gsm film + | Black |
| 45% virgin PP resin | | 17 gsm scrim | |
| SL-3751 (control): 55% GF + | 1000 | 70 gsm film + | Black |
| 45% virgin PP resin | | 20 gsm scrim | |
| ST-14894: 50% GF + 25% | 1000 | 60 gsm film + | Black |
| virgin PP resin + 20% recycled | | 20 gsm scrim | |
| PP resin + 5% reproduced PET | | | |
| fibers | | | |
| ST-14895: 45% GF + 25% | 1000 | 60 gsm film + | Black |
| virgin PP + 20% recycled PP | | 20 gsm scrim | |
| resin + 10% reproduced PET | | | |
| fibers | | | |
| ST-14896: 55% GF + 20% | 1000 | 60 gsm film + | Black |
| virgin PP + 25% recycled PP | | 20 gsm scrim | |
| resin | | | |
| ST-14897: 55% GF + 15% | 1000 | 60 gsm film + | Black |
| virgin PP + 30% recycled PP | | 20 gsm scrim | |
| resin | | | |

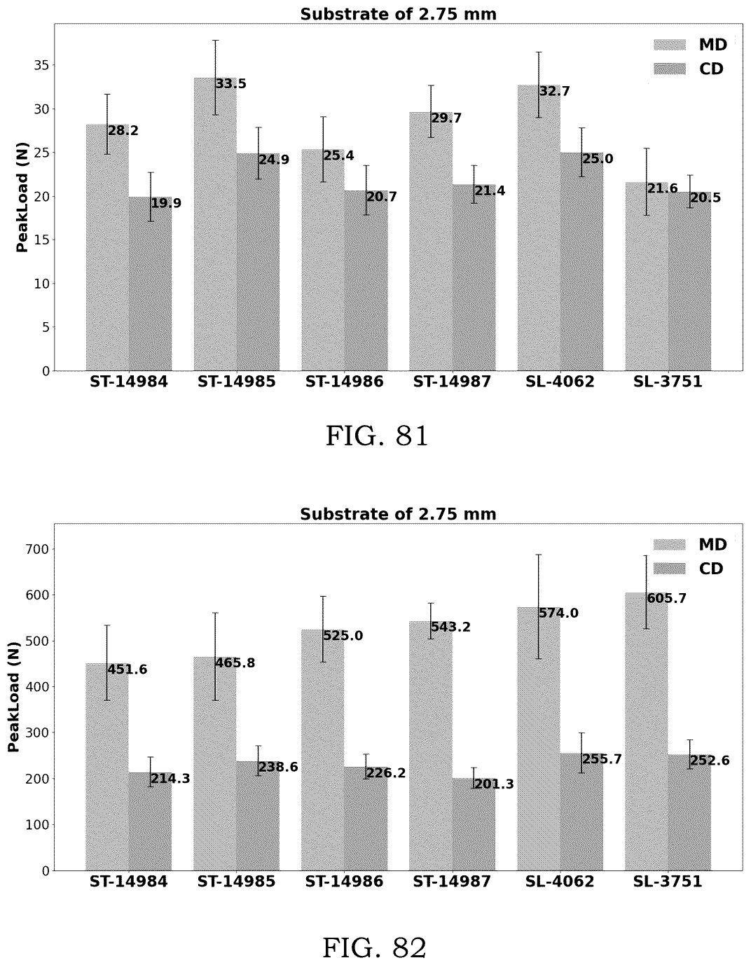

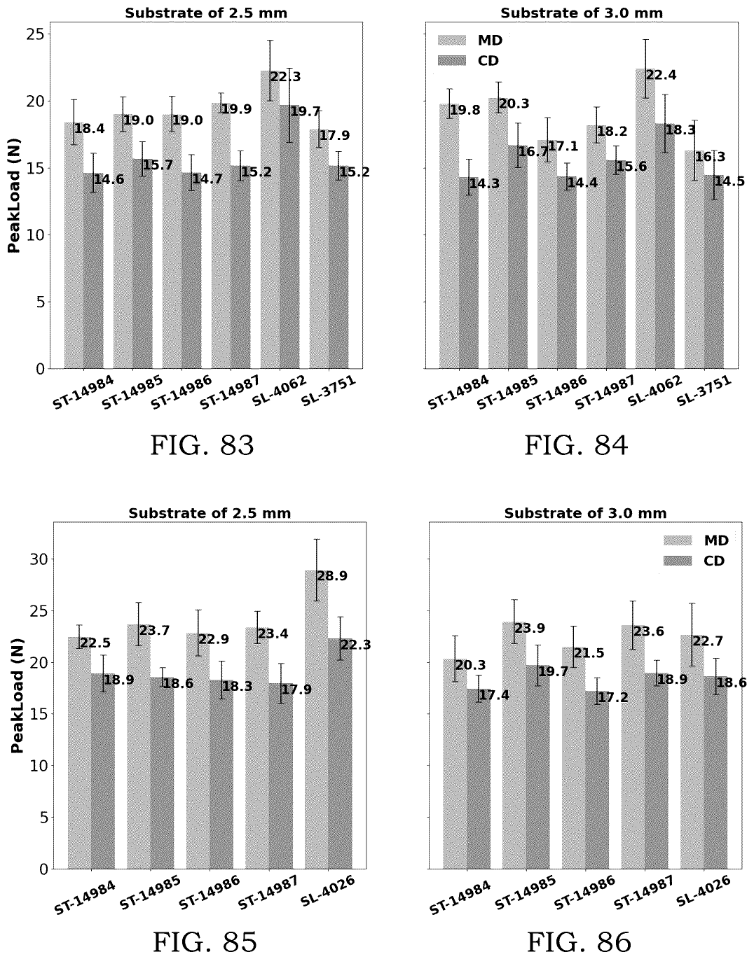

ISO-flex peak load values (FIG. 81) and ISO-tensile peak load values (FIG. 82) were measured for a substrate thickness of 2.75 mm. FIGS. 83 and 84 show SAE-flex peak load for substrate only, and FIGS. 85 and 86 show SAE-flex peak load values for substrate plus attached skins at different substrate thicknesses. In each bar graph grouping, the left bar are the machine direction values and the right bar are the cross direction values.

The ISO-flex peak load values were similar for the test specimens compared to the control values in the machine direction. The ISO-tensile peak load values in the cross direction generally were lower compared to the control values. The SAE-flex peak values were similar or lower than the control values at a comparable substrate thickness. Addition of the skins (FIGS. 85 and 86) increased the SAE-flex values compared to the substrates lacking the skins. These results are consistent with recycled resin providing comparable performance as core layers with only virgin resin.

### Example 11

Several test specimens were prepared that included various amounts of recycled resin and/or reproduced PET fibers and various skin layers. The formulations are shown below in Table 9.

TABLE 9

| | Core | | |
|---|---|---|---|
| | gsm | | |
| Formulation | (g/m²) | Skins | Color |
| SL-4062 (control) : 55% GF + | 900 | 40 gsm film + | Black |
| 45% virgin PP resin | | 20 gsm scrim | |
| SL-6820 (control): 55% GF + | 1000 | 40 gsm film + | Black |
| 45% virgin PP resin | | 17 gsm scrim | |
| ST-15085: 55% GF + 25% virgin | 900 | 40 gsm film + | Black |
| PP resin + 20% recycled PP resin + | | 20 gsm scrim | |
| 5% reproduced PET fibers | | | |
| ST-15087: 45% GF + 25% virgin | 900 | 60 gsm film + | Black |
| PP + 20% recycled PP resin + 10% | | 20 gsm scrim | |
| reproduced PET fibers | | | |
| ST-15088: 55% GF + 20% virgin | 1000 | 40 gsm film + | Black |
| PP + 25% recycled PP resin | | 20 gsm scrim | |
| ST-15091: 55% GF + 15% virgin | 1000 | 60 gsm film + | Black |
| PP + 30% recycled PP resin | | 20 gsm scrim | |

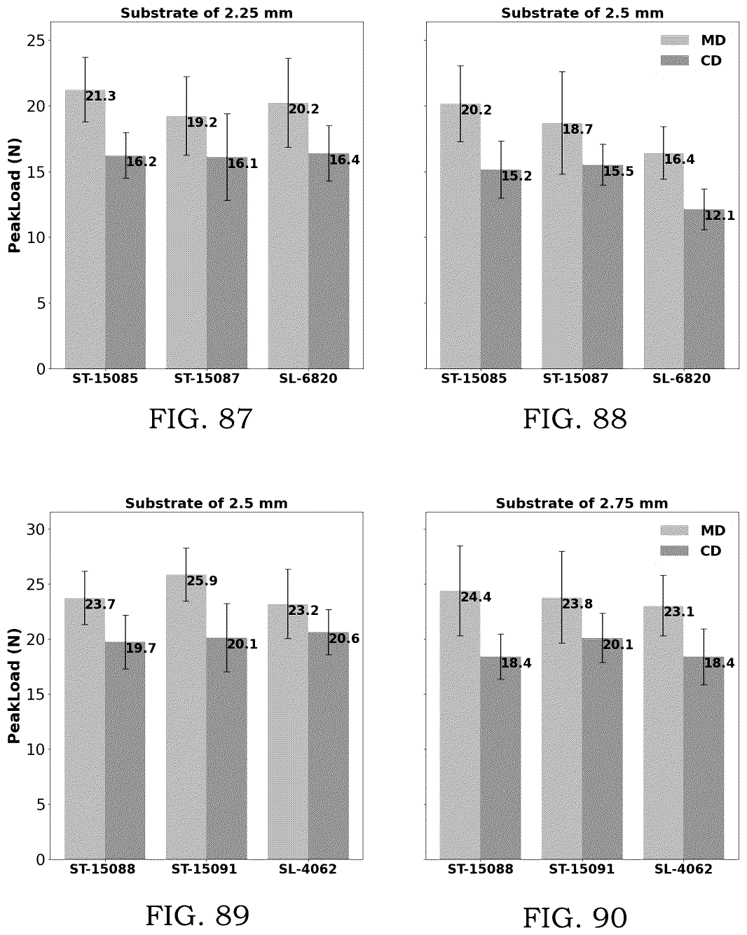

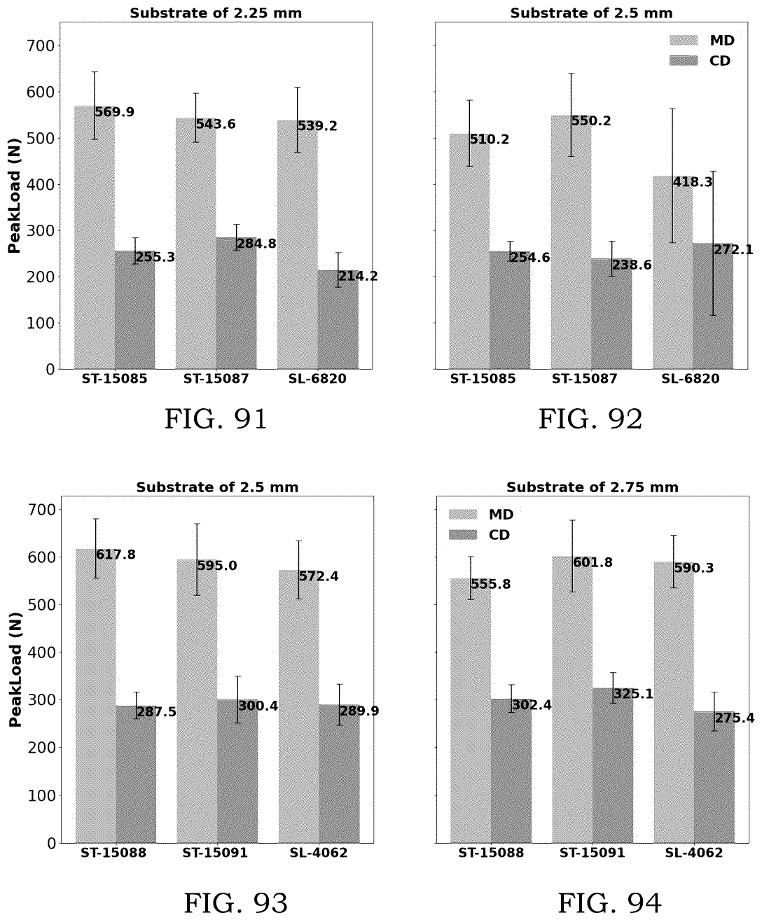

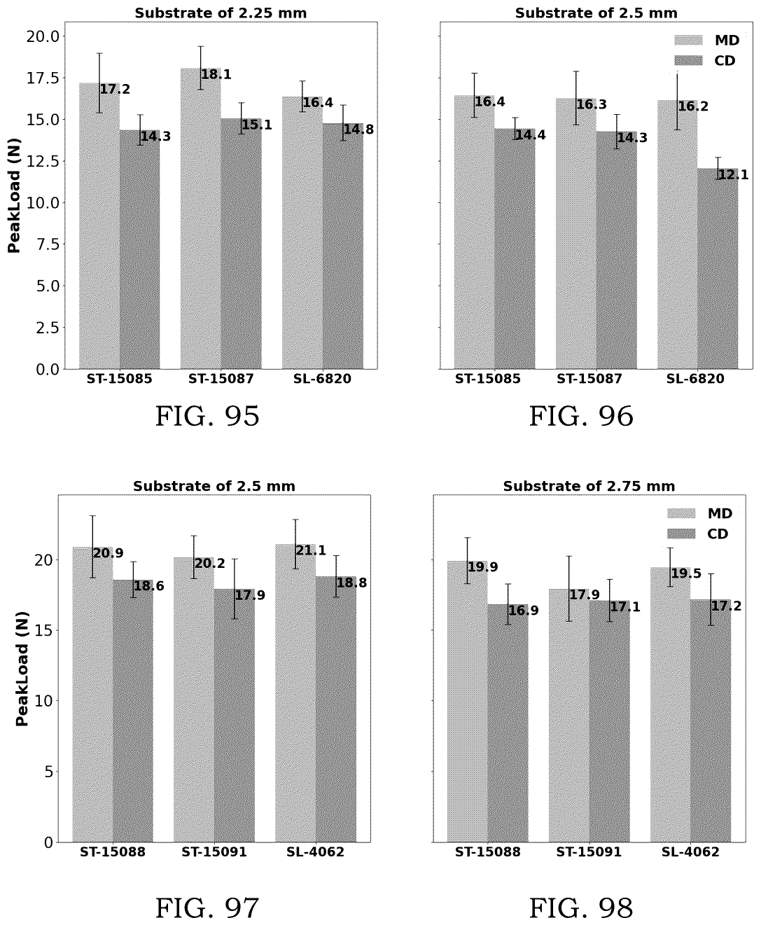

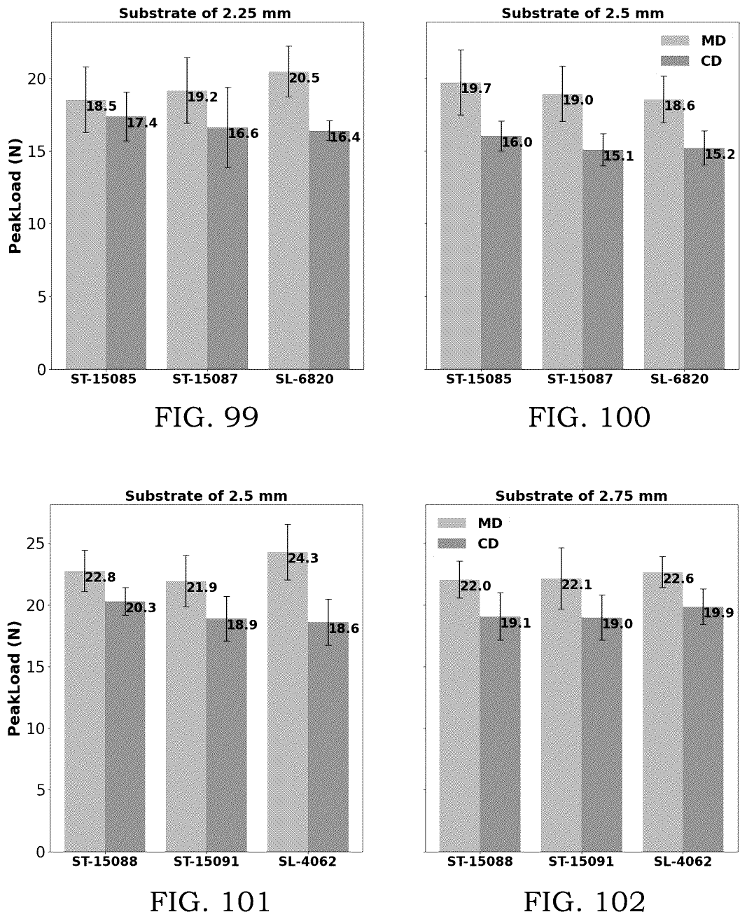

ISO-flex peak load values (FIGS. 87-90) and ISO-tensile peak load values (FIGS. 91-94) were measured for different substrate thicknesses. FIGS. 95-98 show SAE-flex peak load for substrate only, and FIGS. 99-102 show SAE-flex peak load values for substrate plus attached skins at different substrate thicknesses. In each bar graph grouping, the left bar are the machine direction values and the right bar are the cross direction values.

The ISO-flex peak load values were similar or better for the test specimens compared to the control values in the machine and cross directions. The ISO-tensile peak load values in the machine and cross directions were also similar to the control values. The SAE-flex peak values were similar to the control values at a comparable substrate thickness. Addition of the skins (FIGS. 101 and 102) increased the SAE-flex values compared to the substrates lacking the skins. These results are consistent with recycled resin and reproduced polymeric fibers providing comparable performance as core layers with only virgin resin and glass fibers.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A thermoplastic composite article comprising:
a porous core layer comprising a web of open celled structures comprising random crossing over of a plurality of reinforcing fibers and a plurality of reproduced polymeric fibers held together by a thermoplastic material; and
a skin layer disposed on a first surface of the porous core layer.

2. The thermoplastic composite article of claim 1, wherein the reproduced polymeric fibers are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

3. The thermoplastic composite article of claim 1, wherein the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethylene terephthalate, a polybutylene terephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

4. The thermoplastic composite article of claim 1, wherein the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, biofibers, rice hull fibers, Kenaf fibers and combinations thereof.

5. The thermoplastic composite article of claim 1, wherein the skin layer is selected from the group consisting of a fabric, a film, a scrim, a frim, a porous non-woven material, a porous knit material, a decorative layer, and combinations thereof.

6. The thermoplastic composite article of claim 1, wherein the plurality of reinforcing fibers are present from 20 weight percent to 80 weight percent based on the weight of the porous core layer.

7. The thermoplastic composite article of claim 1, wherein the plurality of reproduced polymeric fibers are present from 20 weight percent to 80 weight percent based on the weight of the porous core layer.

8. The thermoplastic composite article of claim 1, wherein the plurality of reproduced polymeric fibers comprise a different monomer unit than a monomer unit of the plurality of reinforcing fibers.

9. The thermoplastic composite article of claim 1, wherein the plurality of reproduced polymeric fibers and the plurality of reinforcing fibers each comprise a similar average diameter and average length.

10. The thermoplastic composite article of claim 1, wherein the thermoplastic composite article is constructed and arranged as a vehicular panel, a vehicular underbody panel, an exterior automotive part, an interior automotive part, an automotive headliner, a recreational vehicle panel or a recreational vehicle part.

11. The thermoplastic composite article of claim 1, wherein the skin layer comprises a plurality of reproduced polymeric fibers.

12. The thermoplastic composite article of claim 11, wherein the plurality of reproduced polymeric fibers of the porous core layer and the plurality of reproduced polymeric fibers of the skin layer independently are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

13. The thermoplastic composite article of claim 11, wherein the plurality of reproduced polymeric fibers of the porous core layer and the plurality of reproduced polymeric fibers of the skin layer comprise a different monomer unit.

14. The thermoplastic composite article of claim 11, wherein the thermoplastic material of the porous core layer comprises at least one of a virgin polyethylene, a virgin polypropylene, a virgin polystyrene, a virgin polyimide, a virgin polyetherimide, a virgin acrylonitrylstyrene, a virgin butadiene, a virgin polyethylene terephthalate, a virgin polybutylene terephthalate, a virgin polybutylenetetrachlorate, a virgin polyvinyl chloride, a virgin polyphenylene ether, a virgin polycarbonate, a virgin polyestercarbonate, a virgin polyester, a virgin acrylonitrile-butylacrylate-styrene polymer, a virgin amorphous nylon, a virgin polyarylene ether ketone, a virgin polyphenylene sulfide, a virgin polyaryl sulfone, a virgin polyether sulfone, a virgin poly(1,4 phenylene) compound, a recycled polyethylene, a recycled polypropylene, a recycled polystyrene, a recycled polyimide, a recycled polyetherimide, a recycled acrylonitrylstyrene, a recycled butadiene, a recycled polyethylene terephthalate, a recycled polybutylene terephthalate, a recycled polybutylenetetrachlorate, a recycled polyvinyl chloride, a recycled polyphenylene ether, a recycled polycarbonate, a recycled polyestercarbonate, a recycled polyester, a recycled acrylonitrile-butylacrylate-styrene polymer, a recycled amorphous nylon, a recycled polyarylene ether ketone, a recycled polyphenylene sulfide, a recycled polyaryl sulfone, a recycled polyether sulfone, a recycled poly(1,4 phenylene) compound, a recycled silicone and mixtures thereof.

15. The thermoplastic composite article of claim 11, wherein the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof.

16. The thermoplastic composite article of claim 11, wherein the skin layer is selected from the group consisting of a fabric, a film, a scrim, a frim, a porous non-woven material, a porous knit material, a decorative layer, and combinations thereof.

17. The thermoplastic composite article of claim 1, wherein the plurality of reinforcing fibers and the plurality of reproduced polymeric fibers of the porous core layer are independently present from 20 weight percent to 80 weight percent based on the weight of the porous core layer.

18. The thermoplastic composite article of claim 11, wherein the plurality of reproduced polymeric fibers of the skin layer comprise a different monomer unit than a monomer unit of the plurality of reinforcing fibers of the porous core layer.

19. The thermoplastic composite article of claim 1, wherein the thermoplastic material of the porous core layer comprises virgin polyolefin material or recycled polyolefin material or both, the plurality of reinforcing fibers of the porous core layer comprise glass fibers, and the plurality of reproduced polymeric fibers of the porous core layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

20. The thermoplastic composite article of claim 11, wherein the thermoplastic material of the porous core layer comprises virgin polyolefin material or recycled polyolefin material or both, the plurality of reinforcing fibers of the porous core layer comprise glass fibers, and the plurality of reproduced polymeric fibers of the skin layer are selected from the group consisting of reproduced polyethylene terephthalate fibers, reproduced polyethylene fibers, reproduced polypropylene fibers, reproduced polyamide fibers, reproduced co-polyamide fibers, reproduced high density polyethylene fibers, and combinations thereof.

21-35. (canceled)
